(19) United States
(12) Patent Application Publication
(10) Pub. No.: US 2023/0191257 A1
(43) Pub. Date: Jun. 22, 2023

(54) INFORMATION PROCESSING SYSTEM, INFORMATION PROCESSING METHOD, AND NON-TRANSITORY TANGIBLE COMPUTER-READABLE MEDIUM

(71) Applicants: GREE, INC., Tokyo (JP); BANDAI NAMCO ENTERTAINMENT INC., Tokyo (JP)

(72) Inventor: Hikaru IDE, Tokyo (JP)

(73) Assignees: GREE, INC., Tokyo (JP); BANDAI NAMCO ENTERTAINMENT INC., Tokyo (JP)

(21) Appl. No.: 17/935,654

(22) Filed: Sep. 27, 2022

(30) Foreign Application Priority Data
Dec. 20, 2021 (JP) 2021-206089

(51) Int. Cl. A63F 13/58; A63F 13/44

(52) U.S. Cl. CPC A63F 13/58; A63F 13/44; A63F 2300/638; A63F 2300/65

(57) ABSTRACT

An information processing system having a processing circuitry that determines whether a predetermined start condition including consumption of a predetermined game medium is met, automatically realizes a predetermined advancement of a game part with a first attribute associated with one user when it is determined that the predetermined start condition is met, determines a setting value of a first parameter based on a consumed amount of the predetermined game medium or a consumed type of the predetermined game medium, the first parameter being related to advancement of the game part with the first attribute, starts to count the first parameter to be updated toward the determined setting value of the first parameter, when it is determined that the predetermined start condition is met, and allows a termination result of the predetermined advancement to be output, when an updated counting value of the first parameter meets a predetermined output condition, the termination result of the predetermined advancement being determined based on the updated counting value of the first parameter or on the setting value of the first parameter as determined.

### CROSS-REFERENCE TO RELATED APPLICATIONS

This application claims the benefit of priority based on Japanese Patent Application No. 2021-206089, which is a prior application filed on Dec. 20, 2021, the entire contents of which are incorporated herein by reference.

### FIELD

The present disclosure relates to an information processing system, an information processing method, and a non-transitory tangible computer-readable medium.

### BACKGROUND

It is known that, when a game part is interrupted, the game may be restarted in a state where the game part reproduces a game state at the time of interruption. For example, there is a known technique in which, when a selective card is determined by lottery but a game part is interrupted in a state where selection of a character related thereto has not been completed, processing of selecting a character related to the selective card as determined is performed prior to restarting the game part.

### CITATION LIST

### Patent Literature

### Patent Literature 1: JP-A-2019-150561

### SUMMARY

### Technical Problem

There is a game in which, by clearing again a game part that has been cleared, it is possible to acquire a game medium for reward (e.g., an item etc.), associated with the game part. In such a game, by clearing the game part many times, it may be possible to efficiently increase a value of a game parameter. However, it is burdensome and apt to feel monotonous for a user to play many times the game part that has already been played.

In contrast, in a case where advancement of a game part is automated, a user sets values of various parameters of a game medium in advance, thereby an operation load of the user caused by his/her manual operation is significantly reduced. However, advancing processing of the game part by such automation would result in a processing load for updating and displaying automatically advancing status at high speed and in real time becoming relatively higher. Therefore, during such automated processing, it is difficult to make acceptable other operations not related to the automated advancement in order to avoid increasing of the processing load. That is, it is difficult to improve operational flexibility of the user during automated processing (i.e., a relatively higher operational flexibility that allows other game parts to be played), to make acceptable other operations of eliminating the monotony of automated advancement.

Taking the above into consideration, an aspect of the present disclosure is to improve operational flexibility of a user until a result of predetermined advancement becomes able to be output, while automating predetermined advancement of a game part.

### Solution to Problem

According to an aspect of the present disclosure, provided is an information processing system comprising: a processing circuitry, wherein the processing circuitry is configured to be executable of: determining whether a predetermined start condition including consumption of a predetermined game medium is met; automatically realizing a predetermined advancement of a game part with a first attribute associated with one user when it is determined that the predetermined start condition is met; determining a setting value of a first parameter based on a consumed amount of the predetermined game medium or a consumed type of the predetermined game medium, the first parameter being related to advancement of the game part with the first attribute; starting to count the first parameter to be updated toward the determined setting value of the first parameter, when it is determined that the predetermined start condition is met; and allowing a termination result of the predetermined advancement to be output, when an updated counting value of the first parameter meets a predetermined output condition, wherein the termination result of the predetermined advancement is determined based on the updated counting value of the first parameter or on the determined setting value of the first parameter.

### Advantageous Effects of Invention

According to an aspect of the present disclosure, it is possible to improve operational flexibility of a user until a result of predetermined advancement becomes able to be output, while automating predetermined advancement of a game part.

### BRIEF DESCRIPTION OF DRAWINGS

FIG. 1 is a block diagram of a game system according to an embodiment of the present disclosure;

FIG. 2 is a diagram showing information about a user;

FIG. 3 is a diagram showing information about an owned game medium;

FIG. 4A is an explanatory diagram of evolution of a first game medium;

FIG. 4B is an explanatory diagram of reinforcement of a first game medium;

FIG. 5 is a diagram showing an example of a play screen displayed on a terminal device;

FIG. 6 is an explanatory diagram of a configuration of an advanceable game part;

FIG. 7 is a block diagram showing a function related to an automatic lap among various functions of a terminal device;

FIG. 8 is an explanatory diagram of advancing information associated with a user;

FIG. 9 is an explanatory diagram of a user interface functioning as a setting screen for an automatic lap;

FIG. 10 is an explanatory diagram of a user interface inclusive of a start button for performing a lap start input;

FIG. 11 is an explanatory diagram of a user interface for accepting a second predetermined user's input;

FIG. 12 is an explanatory diagram of an output screen showing a termination result in an automatic lap of a battle game part;

FIG. 13 is an explanatory diagram of an example in a case where a function related to automatic lap is distributed to and realized by a terminal device and a server device;

FIG. 14 is a flowchart (No. 1) showing an operational example of a game system related to an automatic lap function;

FIG. 15 is a flowchart (No. 2) showing an operational example of a game system related to an automatic lap function;

FIG. 16 is a schematic flowchart showing an example of a method of calculating various values required for generating an automatic lap setting screen and subsequent processing related thereto;

FIG. 17 is a schematic flowchart showing an example of an automatic lap related processing (i.e., Step S1618) shown in FIG. 16;

FIG. 18 is a schematic flowchart showing an example of a method of calculating various values required for generating an interruption confirmation screen;

FIG. 19 is a schematic flowchart illustrating a success/failure determination processing of a predetermined start condition related to an automatic lap of a battle game part for multi-play; and

FIG. 20 is a schematic flowchart showing an example of a method of calculating various values required for generating an automatic lap setting screen for multi-play and subsequent processing related thereto.

### DETAILED DESCRIPTION OF EMBODIMENTS

Hereinafter, embodiments are described in detail with reference to the attached drawings.

### [Overview of a Game System]

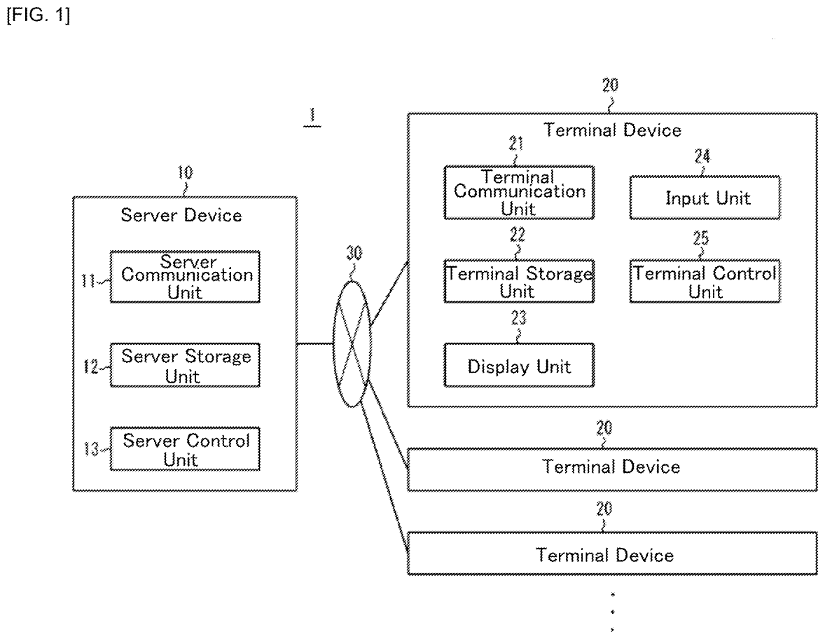

An outline of a game system 1 according to an embodiment of an information processing system of the present disclosure is described with reference to FIG. 1. The game system 1 includes a server device 10 and one or more terminal device(s) 20. Although three terminal devices 20 are shown in FIG. 1 for convenience, the number of the terminal devices 20 may be two or more in a case of a plurality thereof. The game system 1 includes at least one processor, and the processor may include processing circuitry, and a memory having one or more instructions stored therein. The processing circuitry is configured to, by executing the instructions stored in memory, execute processing as described in the present disclosure. It is noted that the memory may be provided outside of the processor.

The server device 10 is an information processing device such as a server managed by a game manager, for example. The terminal device 20 is an information processing device used by a user, such as a mobile phone, a smartphone, a tablet terminal, a PC (Personal Computer), or a game machine. The terminal device 20 is able to execute a game application according to the present disclosure (hereinafter also referred to as “the present game application”). The present game application may be received by the terminal device 20 from a predetermined application distributing server via a network 30 or may be stored in advance in a storage device provided for the terminal device 20 or a storage medium such as a memory card readable by the terminal device 20. The server device 10 and the terminal device 20 are communicably connected via the network 30. For example, the server device 10 and the terminal device 20 execute various processing related to the game in cooperation with each other. In a case where the terminal device 20 is a so-called mobile type or portable type, the game is often played at a visiting place outside, while moving, or in a spare time, and then, it becomes often difficult to play the game for a long time. Therefore, even in a mobile game suitable for the terminal device 20 in a mobile type, a game part that requires a relatively long playing time tends to be avoided by a user. In the present disclosure, by constructing a mechanism for substantially increasing a playing time of such game part even for a user who has difficulty in playing the game for a long time, it becomes possible to increase choices of a user in the mobile game.

Note that, in the present disclosure, each element of each terminal device 20 (see a terminal communication unit 21 to a terminal control unit 25 shown in FIG. 1), realizes an example of the information processing system, and alternatively, each terminal device 20 and the server device 10 may realize an example of the information processing system in cooperation with each other, or the server device 10 alone may realize an example of the information processing system.

Note that, examples of the network 30 may include a wireless communication network, the Internet, a VPN (Virtual Private Network), a WAN (Wide Area Network), a wired network, or any combination thereof.

### (Outline of the Game)

An outline of the game according to the present disclosure is described. The game according to the present disclosure includes one or more game part(s). At least one game part of the one or more game parts may be executed using a game medium.

The game medium is electronic data to be used in the game, and examples thereof include any medium such as a card, an item, a point, an in-service currency (or an in-game currency), a token (e.g., Non-Fungible Token (NFT)), a ticket, a character, an avatar, a parameter, etc. Further, examples of the game medium may include game-related information such as status information, game parameter information (e.g., physical fitness value, offensive power), capability information (e.g., skill, ability, magic spell, job). The game medium is electronic data able to be acquired, owned, used, managed, exchanged, synthesized, reinforced, sold, discarded, or donated by a user in the game, but such use mode is not limited to what explicitly indicated in the present description.

Hereinafter, unless otherwise explicitly indicated, a “game medium owned by a user” means a game medium associated with a uniquely identifiable user ID of the user as the owned game medium. Further, “providing a game medium for a user” means associating the game medium with the user ID as the owned game medium. Further, “discarding a game medium owned by a user” means canceling association between the user ID and the owned game medium. Further, “consuming a game medium owned by a user” means being able to generate some effect or influence in the game depending on cancelling association between the user ID and the owned game medium. Further, “selling a game medium owned by a user” means cancelling association between the user ID and the owned game medium and associating another game medium (e.g., a virtual currency, an item), with the user ID as an owned game medium. Further, “transferring a game medium owned by a user A to a user B” means cancelling association between the user ID of the user A and the owned game medium and associating the game medium with the user ID of the user B as an owned game medium. Further, “creating a game medium” means defining or determining at least a part of information about game medium.

The game part is one of contents playable by the user in the game, and examples thereof include a quest, a mission, a mini-game, development, reinforcement and synthesis of a game medium, a game medium acquisition event, an exploration event in virtual space, a battle event with an opponent (e.g., another user, an enemy character, an enemy building). One or more predetermined task(s) (i.e., one or more game task(s)) may be set for each game part. For example, when it is determined that one or more game task(s) set in the game part played by a user has/have been successfully achieved, a game medium or the like may be provided for the user as a reward. Examples of the game task include a task of winning a battle with an enemy character, a task of reaching a goal point in a virtual space, and a task of not becoming a predetermined state into which a user character is fell (e.g., an action-disable state), until a predetermined time elapses, and any task is employable according to a content of the game part. Further, achieving a particular task (i.e., a to-be-cleared task) among one or more game task(s) set in the game part is also referred to as clearing the game part. When a user who plays the game part succeeds in achieving the to-be-cleared task, it is determined that the game part is cleared, and then the game part may terminate.

One or more game part(s) may include a game part for single-play and a game part for multi-play. The game part for single-play may include, for example, a game part to be executed based on a user operation on one terminal device 20 used by one user (e.g., a game part for one person). For example, one terminal device 20 alone or one terminal device 20 and the server device 10 in cooperation with each other executes or execute the game part for single-play. On the other hand, the game part for multi-play may include, for example, a game part in common with two or more users to be executed based on a user operation on two or more terminal devices 20 used by two or more users, respectively (e.g., a game part for plural persons). The game part in common with two or more users may include, for example, a game part in which at least a part of advancing processing of the game part and at least a part of processing results are applied to the two or more users in common. For example, two or more terminal devices 20 in cooperation with each other, or two or more terminal devices 20 and the server device 10 in cooperation with each other execute the game part for multi-play. One game part may support both single-play and multi-play.

As an example, the game according to the present disclosure include a battle game part having a configuration of a side-scrolling action game and a configuration of a battle game in which a battle is played against an opponent using a game medium (as an example of a game part of a first attribute). The user selects one or more game medium(a) to be used for the battle game part among the game media owned by the user (i.e., the owned game media). -Hereinafter, each game medium to be used for the battle game part is also referred to as a first game medium. The one or more first game media is/are collectively referred to as a deck (i.e., a unit) or a team. The opponent is, for example, an automatically operated game medium such as an NPC (Non-Player Character), but it is not limited thereto. For example, the opponent may be a game medium operated by another user. In one battle game part, the number of opponents may be optionally set.

An outline of the battle game part according to the present disclosure is described. A user who plays the battle game part for single-play using the terminal device 20 operates a moving object arranged in a virtual space to acquire a predetermined item while avoiding obstacles and the like, for example. The moving object corresponds to a predetermined game medium (i.e., a second game medium). Examples of the second game medium may include a motorcycle, a car, a person. Depending on acquisition of an item, a game medium (i.e., a first game medium) included in the deck performs a predetermined action (e.g., an attack against an opponent). The actions of the first game medium may cause damage to the opponent. On the other hand, the opponent performs a predetermined action (e.g., an attack against the user) at a predetermined time interval, for example. The actions of the opponent may cause damage to the user. For each of the user and the opponent, a predetermined parameter is set to be decreased by amount of damage caused. When the predetermined parameter of the opponent is decreased to a predetermined value (e.g., zero), it is determined that the user has won. On the other hand, when the predetermined parameter of the user is decreased to a predetermined value (e.g., zero), it is determined that the user has lost. When it is determined that the user has won or lost, the battle game part may terminate.

On the other hand, the battle game part for multi-play is executed in the same manner as the battle game part for single-play as described above, except that two or more users play against a common opponent. Specifically, each of the two or more users plays the battle game part in common using his/her individual terminal device 20. Each of the two or more users operates the second game media in the virtual space as described above. As the virtual space, a virtual space common to the two or more users may be used, or a virtual space independent for each user may be used. The first game medium included in each deck of the two or more users makes an attack against the common opponent, for example. The above-mentioned predetermined parameter of the opponent is commonly applied to the two or more users. For example, the predetermined parameter of the opponent may be synchronized between the plurality of terminal devices 20 individually used by the two or more users. When the predetermined parameter of the opponent is decreased to a predetermined value (e.g., zero), it is determined that two or more users have won. On the other hand, when the predetermined parameter of each of the two or more users is decreased to a predetermined value (e.g., zero), it is determined that the two or more users have lost. When it is determined that two or more users have won or lost, the battle game part may terminate.

Further, the game according to the present disclosure includes an advancing game part covering a plurality of battle game parts in units of the battle game part as described above. That is, the game according to the present disclosure includes an advancing game part as a complex of a plurality of battle game parts. The number of the plurality of battle game parts constituting the advancing game part may be optionally set, and a relatively large number may be adapted (e.g., 30 to 50). Note that the advancing game part may be set in plural types. Here, an in-game may include not only the “advancing game part”, but also one continuous large game part. Examples of the in-game include not only a game of battling but also a game of various genres such as a RPG, an exploration, a game of clearing missions, a game of reading scenarios, a game of selecting an option to develop it, etc. In the following, one advancing game part is described unless otherwise specified.

The plurality of battle game parts constituting the advancing game part may be the same in all or in part, but it may be that the types thereof may be different from each other. For example, it may be different in terms of an opponent, a difficulty level, a reward, a story, and the like between one battle game part constituting the advancing game part and the other battle game part constituting the same advancing game part. Further, the advancing game part may not be a mere collection of individually independent battle game parts (hereinafter also referred to as an “independent battle game part” to distinguish it from the advancing game part), but each of the battle game parts constituting the advancing game part may be characteristically made different from individuals of the independent battle game parts in terms of an opponent, a difficulty level, a reward, a story, and the like.

Further, the plurality of battle game parts constituting the advancing game part may be set to be executable in any order, but it may be that they are set to be executable in a predetermined order. For example, the plurality of battle game parts constituting the advancing game part may be set to be executable in a predetermined order along with a predetermined story.

Further, the game according to the present disclosure includes a game part related to a so-called out-game (hereinafter also referred to as an “out-game part”) (an example of a game part with a second attribute). The out-game part does not involve a battle by the game medium, or is less in battle frequency than the battle game part. The out-game part is, for example, a game part which relates to development, reinforcement, synthesis, and the like of the owned game medium and allows capability parameters, game functions, etc., as described later, to be changed. Examples of the out-game part include not only reinforcement and others but also mini-game different from the in-game (e.g., puzzles, fishing, simple missions). Alternatively, the out-game part may be a game distinct from the advancing game part, such as town development.

### (Configuration of Server Device)

The configuration of the server device 10 is specifically described. The server device 10 is composed of a server computer. The server device 10 may also be realized by a plurality of server computers in cooperation therewith.

The server device 10 includes a server communication unit 11, a server storage unit 12, and a server control unit 13. These units arc realized by the circuitry as described above.

### (Server Communication Unit)

The server communication unit 11 includes an interface for transmitting and receiving information by communicating with an external device by wireless or by wire. The server communication unit 11 may include, for example, a wireless LAN (Local Area Network) communication module, a wired LAN communication module, or the like. The server communication unit 11 is able to transmit and receive information with the terminal device 20 via the network 30.

### (Server Storage Unit)

The server storage unit 12 includes, for example, a primary storage device and a secondary storage device. For example, the server storage unit 12 may include a semiconductor memory, a magnetic memory, an optical memory, or the like. The server storage unit 12 stores various information and programs used for processing of the game. At least a part of the information and the programs stored in the server storage unit 12 may be shared and synchronized with the terminal device 20. Hereinafter, an example of the information stored in the server storage unit 12 is specifically described.

### (Information About User)

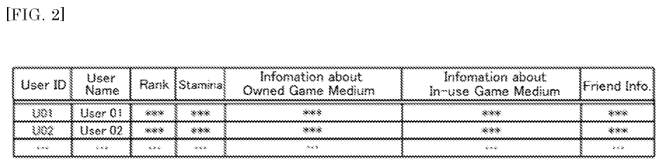

The server storage unit 12 stores information about each of the plurality of users. The information about user is described with reference to FIG. 2. FIG. 2 shows the information about each of two users. The information about user includes various information characteristic to the users. Examples of the information about user include a user ID, a username, a rank, stamina, information about owned game medium, information about in-use game medium, and information about friend. In the information about user, each of the plurality of users, information about owned game medium and information about in-use game medium, and information about friend are associated with each other.

The user ID is information uniquely identifiable of a user. Hereinafter, a user ID is also simply referred to as a user.

The username is information indicating a name of a user. Unlike the user TD, the username does not have to be uniquely identifiable of a user. The username may be optionally determined and changed according to a user operation on the terminal device 20.

The rank is a parameter indicating a user's skill level regarding the game. In the present disclosure, a value of the rank may be increased according to the user's play of the game. The higher the rank, the higher the user's skill level regarding the game becomes.

The stamina is a parameter (i.e., one of a game medium) consumed in playing the game part. The consumption of stamina may be set for each game part. The stamina is updated in such a manner that it is gradually increased to an upper limit over time.

The upper limit of the stamina may be different for each user. For example, the upper limit of the stamina may be increased together with the rank. Further, the stamina may also be increased by consumption of a particular game medium (e.g., in-service currency).

The information about owned game medium includes various information characteristic to a game medium owned by a user in the game (i.e., an owned game medium). When the game medium is acquired by a user, the game medium is associated with the user as the owned game medium. Details of the information about owned game medium is described later.

The information about in-use game medium is information indicating a game medium (i.e., a first game medium) to be used by a user in the battle game part. The first game medium is selected among the owned game media. In the present disclosure, for example, a maximum of five game media selected among the owned game media are associated with the user as the first game media, respectively. Therefore, one game medium may be one of the owned game media as well as one of the first game media. The first game medium may be, for example, in an exclusive game part, selected automatically or depending on a user operation. For example, the exclusive game part may include a game part in which so-called deck formation, team formation, or the like is organized. A maximum of five first game media shown in the information about in-use game medium constitutes one deck. The information about in-use game medium may include information about a plurality of decks.

The information about friend represents a user ID having a friend relationship. For example, when a user A has a friend relationship with users B and C, the information about friend associated with the user A includes the user IDs of the users B and C. The friend relationship is realized through an application for friend or the like. In this way, the information about friend includes user IDs of other users that are unidirectionally or bidirectionally associated with users. Note that the users in a friendship relationship may be allowed to communicate with each other, for example, by transmitting and receiving messages on the game system 1. In addition, information indicating a group (e.g., a guild, a party) to which the users belong may be included in the information about user in place of or in addition to the information about friend.

The content of the information about user is not limited to the above. For example, the information about user may further include information indicating a predetermined point that a user holds in the game. The point is consumed for the user to play the game part. A consumption of point may differ for each game part. The point may be increased, for example, depending on elapsing time or use of a predetermined game medium.

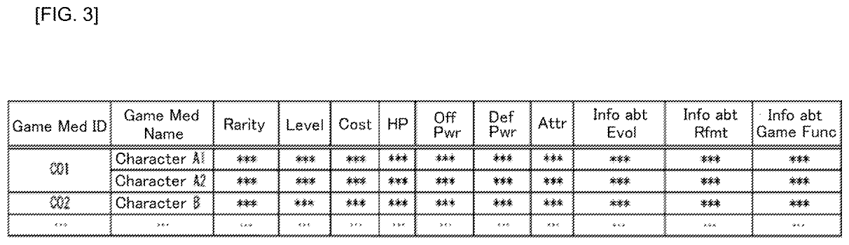

Here, with reference to FIG. 3, an example of the above-mentioned information about owned game medium is described in detail. FIG. 3 shows information about two owned game media associated with one user. For example, the information about each owned game medium includes a game medium ID, a game medium name, rarity, level, cost, HP (Hit Point), offensive power, recovery power, attribute, information about evolution, information about reinforcement and information about game function.

The game medium ID is information uniquely identifiable of the game medium. The game medium ID may be stored in the server storage unit 12 in advance. Alternatively, the game medium ID may be determined by the server device 10 when a user is made to acquire the game medium.

The game medium name is information indicating a name of the game medium. Unlike the game medium ID, the game medium name does not have to be uniquely identifiable of the game medium. An initial value of the game medium name may be stored in the server storage unit 12 in advance. The game medium name may be changed depending on the game play by a user who acquired the game medium.

In the present disclosure, the first game medium is allowed to be evolved stepwise in part or completely. Hereinafter, a game medium evolvable stepwise is also referred to as an “evolvable game medium”. In the present disclosure, as an example, evolution involves an effect of increasing rarity. Note that the evolution may involve changes in game functions (e.g., skill) as described later. Here, for convenience of explanation, the number at the end of the game medium name represents a step of evolution. For example, the game medium “C01” shown in FIG. 3 is an evolvable game medium, and when the game medium “C01” is in a state where it has not been evolved at all, the game medium name is “Character A1”. On the other hand, when the game medium “C01” has been evolved by only one step, the game medium name becomes “Character A2”. The number of steps of the evolution may be optionally set to differ depending on each evolvable game medium.

Further, in the present disclosure, the first game medium is allowed to be reinforced completely. Note that, in a modification, the first game medium may be allowed to be reinforced in part only, or a second game medium as described later may also be allowed to be reinforced. Hereinafter, the game medium reinforceable is also referred to as a “reinforceable game medium”.

The rarity is information indicating degree of rarity (i.e., value of rarity) of the game medium. That is, the rarity associated with a certain game medium represents the difficulty in acquiring the game medium (i.e., the difficulty in drawing the game medium in lottery), and here, the higher the rarity, the more difficult it becomes to be owned.

The level is information indicating degree of growth of the game medium. For example, the greater a value of the level, the greater the degree of growth of the game medium becomes. In the present disclosure, the value of the level may be increased depending on the game play by the user. Further, as for the level related to the first game medium, an upper limit level may be set for each first game medium. In this case, the upper limit level of the first game medium may be set in such a manner that the higher the rarity, the higher the upper limit level becomes. Further, the upper limit level of the first game medium may be allowed to be raised up depending on a particular reinforcement (e.g., breaking through the limit).

The cost is a parameter used when determining a deck to be used for the battle game part. In the present disclosure, a maximum of five first game media is allowed to be included in one deck within a range in which the total cost of each first game medium does not exceed a predetermined upper limit value. The upper limit value may be increased, for example, depending on the rank of the user as increased.

The IIP is a parameter used to determine an outcome of a user in the battle game part. In the present disclosure, the total of the HP of all the first game media included in the deck is used as the upper limit value at the start of the battle game part. Hereinafter, the total value of the HP of all the first game media included in the deck is also referred to as “the total HP of the users”. When the user is damaged by, for example, the attack of the opponent during execution of the battle game part, the total HP is decreased by an amount of the damage. During execution of the battle game part, for example, when a recovery item is acquired, the total HP is increased. When the total HP is decreased to a predetermined value (e.g., zero), it is determined that the users has lost. Therefore, the greater the HP of each first game medium included in the deck, the more advantageous it is for the users. The HP may be increased depending on the level as increased.

The offensive power is information contributing to an amount of damage given to the opponent by, for example, an attack of the game medium. The greater a value of the offensive power, the greater the amount of damage given to the opponent becomes. Therefore, the greater the offensive power of the game medium, the more advantageous it is for the user. The offensive power may be increased depending on the level of the user as increased.

The recovery power is a parameter used during execution of the battle game part. In the present disclosure, the total of the recovery power of all the first game media included in the deck is used. Hereinafter, the total of the recovery power of all the first game media included in the deck is also referred to as “the total recovery power of the users”. During execution of the battle game part, for example, when a recovery item is acquired, the total recovery power of the users is increased. The greater the value of total recovery power, the greater the increment of the total HP becomes. Therefore, the greater the recovery power of each first game medium included in the deck, the more advantageous it is for the users. The recovery power may be increased depending on the level of the user as increased.

Note that, among the above various parameters, the HP, the offensive power and the recovery power are parameters representing the capability of the game medium. Specifically, the higher the HP, the higher the capability of the game medium becomes, and the higher the offensive power, the higher the capability of the game medium becomes, and so on. Further, in a case where the offensive power and others are specified to be increased depending on the level as increased, the level also becomes a parameter representing the capability of the game medium. Further, with respect to the evolvable game medium as described above, in a case where the capability is specified to become higher as the step of the evolution advances, the step of the evolution (i.e., an evolution value) also becomes a parameter representing the capability of the game medium.

In the following, parameters representing the capability of the game medium is also referred to as “capability parameters”. Note that the naming and background of various parameters belonging to the capability parameters may be optionally set, for example, parameters obtained by quantifying an amount of magical energy or physical capability may be adopted.

The attribute is information indicating an attribute of the game medium. Examples of the attribute may include a plurality of first attributes (e.g., a fire attribute, a wood attribute, a water attribute) that indicate chemistry between the game media which play the battle. At least one of the plurality of first attributes is associated with one game medium. For example, a game medium with the fire attribute gives damage greater than usual to a game medium with the wood attribute, and gives damage smaller than usual to a game medium with a water attribute. Thus, for example, the fire attribute is advantageous to the wood attribute and disadvantageous to the water attribute. Examples of the attribute may include a plurality of second attributes (e.g., an attack attribute, a recovery attribute, a physical fitness attribute, a balance attribute) that do not affect chemistry between the game media which play the battle. At least one second attribute of the plurality of second attributes is associated with one game medium. Therefore, for example, a game medium with the fire attribute as the first attribute and the attack attribute as the second attribute may exist.

The information about evolution includes whether or not evolution is possible, and in a case where evolution is possible, a current step of evolution (i.e., an evolution value), a condition for successful evolution (i.e., an evolution realization condition), effect of evolution (e.g., raising up of the rarity), etc. In the present disclosure, as an example, the evolution of a certain game medium involves consumption of a predetermined game medium associated with the certain game medium. In this case, the information about evolution includes information representing the game medium to be consumed for evolution for each evolvable game medium as information about the evolution realization condition. That is, each of the evolvable game media is associated with a game medium to be consumed for evolution (hereinafter also referred to as an “evolutionary material game medium”). The evolutionary material game medium is a game medium usable for evolution, but it does not have to be a game medium that is used only for evolution.

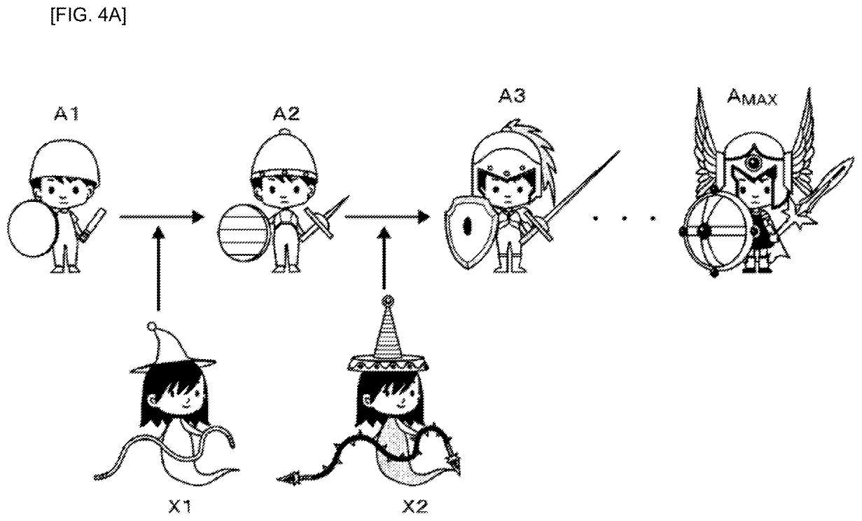

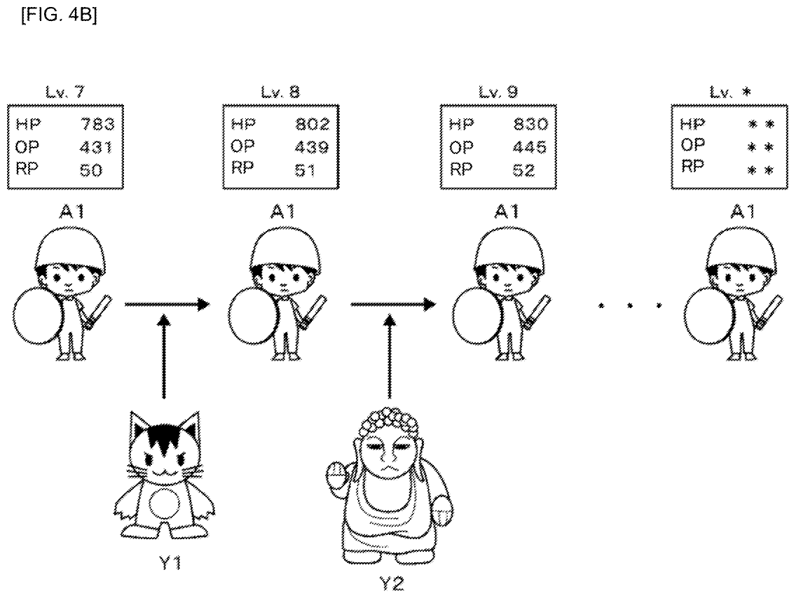

For example, FIG. 4A shows an example of an evolutionary mode of a certain game medium (here, the game medium “C01” shown in FIG. 3). In FIG. 4A, shown is a situation where the game medium “C01”, which is an evolvable game medium, is in evolving. In this case, the game medium “C01” is evolvable up to the upper limit in such a way of from Character A1 to Character A2, and then, from Character A2 to Character A3 for each evolution. Note that, in FIG. 4A, shown is Character AMAX expressing the evolvable game medium that has reached the upper limit.

Further, in FIG. 4A, shown are two game media named Characters X (X1 and X2) as the evolutionary material game media. Note that a game medium corresponding to Character X may be an evolvable game medium or an un-evolvable game medium. Further, the evolutionary material game medium to be associated may be different or the same for each evolvable game medium. Further, in FIG. 4A, evolving the more evolved game medium “C01” (e.g., Character A2) involves consumption of a more evolved evolutionary material game medium (i.e., the evolutionary material game medium X2 more evolved than the evolutionary material game medium X1), but it is not limited thereto. For example, the evolutionary material game medium may always be a game medium that is not evolved (here, the evolutionary material game medium

Note that, in FIG. 4A, the evolutionary material game medium is different from the evolvable game medium to be associated, but it may be the same thereto. Examples of the evolutionary material game medium to be associated with the game medium “C01”, which is an evolvable game medium, may include the game medium “C01”.

Further, in FIG. 4A, the number of the evolutionary material game media used for evolution of the evolvable game medium is only one at once, but it is not limited thereto. That is, the evolution of the evolvable game medium at once may involve consumption of two or more evolutionary material game media.

The information about reinforcement includes whether or not reinforcement is possible, and in a case where reinforcement is possible, a condition for reinforcement (i.e., a reinforcement realization condition), effect of reinforcement (e.g., changing rules of status depending on a reinforced mode), etc.

In the present disclosure, as an example, the reinforcement of a certain reinforceable game medium involves consumption of a predetermined game medium (hereinafter also referred to as a “reinforcing material game medium”) utilized for reinforcement as the reinforcement realizing condition. Note that the reinforcing material game medium is a game medium usable for reinforcement, but it does not have to be a game medium that is used only for reinforcement.

For example, FIG. 4B shows an example of a reinforcing mode of a certain game medium (here, the game medium “C01” shown in FIG. 3). In FIG. 4B, shown is a situation where the game medium “C01”, which is a reinforceable game medium, is in being reinforced. In this case, the capability parameters (level (LV.), HP, offensive power, and recovery power in FIG. 4B) of the game medium “C01” are appropriately increased for each reinforcement. Note that the reinforceable game medium becomes un-reinforceable when the level thereof reaches an upper limit level. However, even in this case, the upper limit level may be allowed to be raised up by using an item for “breaking through the limit” or the like.

Further, in FIG. 4B, shown are two game media named Characters Y1 and Y2 as the reinforcing material game media. Characters Y1 and Y2 may be provided with different game medium IDs or may be the same (that is, they may be evolvable game media and may be Characters after evolved). Further, in FIG. 4B, the number of reinforcing material game media used for reinforcement of the reinforceable game medium is only one at once, but it is not limited thereto. That is, the reinforcement of the reinforceable game medium at once may involve consumption of two or more reinforcing material game media.

The information about game function includes information on the game function associated with the game medium. The game function may include a special function (e.g., skill, ability) associated with the game medium. Further, any number of game functions may be associated with one game medium. When the game function is performed, a predetermined game effect may be produced, for example, in the battle game part. The content of the game effect may be optionally set. In the present disclosure, there may exist game effects advantageous to a user. For example, there may exist a game effect that causes more damage to the opponent than a normal attack, or there may exist a game effect that weakens the opponent's attack. The game effect as produced may continue for a predetermined period of time. In the present disclosure, there may exist one or more game function(s) usable in either one or both of the battle game medium for single-play and the battle game medium for multi-play.

The content of information about game function is not limited to the above. For example, the information about game function may further include a level and an experience value of the game function. For example, the experience value of the game function may be increased by consuming a predetermined game medium owned by the user. The predetermined game medium may include, for example, any game medium in which the game function is set. Further, for example, the predetermined game medium may include one or more types of game media predetermined for the game function. When the experience value of the game function reaches a predetermined reference value, the level of the game function may be increased. That is, the game function may be reinforceable. As the level of the game function is increased, the game effect more advantageous to the user may be produced. For example, when the level of the game function is increased, the amount of damage given to the opponent may be increased. Further, the game function may be a special game function to be able to be awoken (e.g., a game function in which the game effect is produced more remarkable than a normal game function). In this case, it may be needed to consume a predetermined item in order to awaken the special game function. Note that, in this case, awakening the special game function is an example of reinforcing the game function.

Note that the various information associated with the game medium ID is not limited to the information as described above with reference to FIG. 3 and is optionally set.

(Information about a game medium being the opponent)

The server storage unit 12 shown in FIG. 1 stores information about a game medium being the opponent (e.g., an NPC) in the battle game part. For example, the information about the game medium being the opponent may include a game medium ID, a game medium name, level, offensive power, defensive power, attribute, and agility of the game medium. Since the game medium ID, the game medium name, the level, the HP, the offensive power, and the attribute are the same to the information about owned game medium as described above, the description thereof is omitted. The HP is a parameter indicating soundness of the opponent. When the HP of the opponent is decreased to a predetermined value (e.g., zero), it may be determined that the user has won against the opponent. When the user has won against all the opponents appearing in the battle game part, it may be determined that the battle game part is cleared. The defensive power is a parameter used to determine the amount of damage given to the opponent. For example, the greater the defensive power, the smaller the amount of damage given to the opponent becomes. The agility is a parameter used to determine an increasing rate of action point of the opponent. For example, the greater the agility, the faster the increasing rate of action point becomes. When the action point reaches an upper limit, the opponent becomes able to perform an action such as an attack.

### (Server Control Unit)

The server control unit 13 shown in FIG. 1 includes one or more processor(s). The processor may include a general-purpose processor realizing a particular function by reading a particular program, and a dedicated processor specialized for a particular processing. The server control unit 13 controls the operation of the server device 10 completely. Hereinafter, an example of the operation of the server control unit 13 is specifically described.

The server control unit 13 makes stored various information and programs used for processing of the game in the server storage unit 12. The information used for processing of the game may include the information about user and the information about game medium being the opponent as described above.

The server control unit 13 transmits and receives information via the server communication unit 11. For example, the server control unit 13 may transmit at least a part of the information stored in the server storage unit 12 to the terminal device 20. In this way, the information stored in the server storage unit 12 and the information stored in the terminal device 20 are shared and synchronized. Examples of timing for sharing and synchronizing the information may include timing when new information is stored in the server storage unit 12 and timing when the information stored in the server storage unit 12 is updated, but it may be optionally set.

The server control unit 13 executes the game in cooperation with the terminal device 20. For example, the server control unit 13 executes the battle game part in cooperation with one or more terminal device(s) 20.

Further, the server control unit 13 may execute a game medium lottery processing for increasing the number of the owned game media of each user. For example, the server control unit 13 receives a lottery request from a user (i.e., a so-called gacha-turning event) and executes the game medium lottery processing. A condition for generating the lottery request is optionally set. For example, the condition for generating the lottery request may be met by consuming a predetermined game medium. Alternatively, the condition for generating the lottery request may be met without consuming a predetermined game medium at the time of campaign or initial registration.

### (Configuration of Terminal Device)

The configuration of the terminal device 20 is specifically described. As shown in FIG. 1, the terminal device 20 includes a terminal communication unit 21, a terminal storage unit 22, a display unit 23, an input unit 24, and a terminal control unit 25. These units are realized by the circuitry as described above.

### (Terminal Communication Unit)

The terminal communication unit 21 includes an interface for transmitting and receiving information by communicating with an external device by wireless or by wire. The terminal communication unit 21 may include, for example, a wireless communication module corresponding to a mobile communication standard such as LTE (Long Term Evolution) (the registered trademark), a wireless LAN communication module, a wired LAN communication module, or the like. The terminal communication unit 21 is able to transmit and receive information with the server device 10 via the network 30.

### (Terminal Storage Unit)

The terminal storage unit 22 includes, for example, a primary storage device and a secondary storage device. For example, the terminal storage unit 22 may include a semiconductor memory, a magnetic memory, an optical memory, or the like. The terminal storage unit 22 stores various information and programs received from the server device 10 and used for processing of the game. The information and programs used for processing of the game may be acquired from an external device via the terminal communication unit 21. For example, the present game application may be acquired from a predetermined application distribution server. Further, for example, a part or all of the information about user and the information about game medium being the opponent may be acquired from the server device 10.

### (Display Unit)

The display unit 23 includes a display device such as a liquid crystal display or an organic EL (Electro-Luminescence) display. The display unit 23 is able to display various screens.

### (Input Unit)

The input unit 24 includes an input interface including a touch panel disposed integrally with, for example, the display unit 23. The input unit 24 is able to accept user's input to the terminal device 20. Further, the input unit 24 may include a physical key, or may further include any input interface including a pointing device such as a mouse.

### (Terminal Control Unit)

The terminal control unit 25 includes one or more processor(s). The terminal control unit 25 controls the operation of the terminal device 20 completely. Hereinafter, an example of the operation of the terminal control unit 25 is specifically described.

The terminal control unit 25 transmits and receives information via the terminal communication unit 21. For example, the terminal control unit 25 receives various information and programs used for processing of the game from at least one of the server devices 10 and another external server. The terminal control unit 25 stores the information and the programs as received in the terminal storage unit 22.

The terminal control unit 25 starts the present game application depending on a user operation. The terminal control unit 25 executes the game in cooperation with the server device 10. For example, the terminal control unit 25 causes the display unit 23 to display various screens used for the game. On the screen, for example, a GUI (Graphic User Interface) for detecting a user operation may be displayed. The terminal control unit 25 is able to detect a user operation onto the screen via the input unit 24.

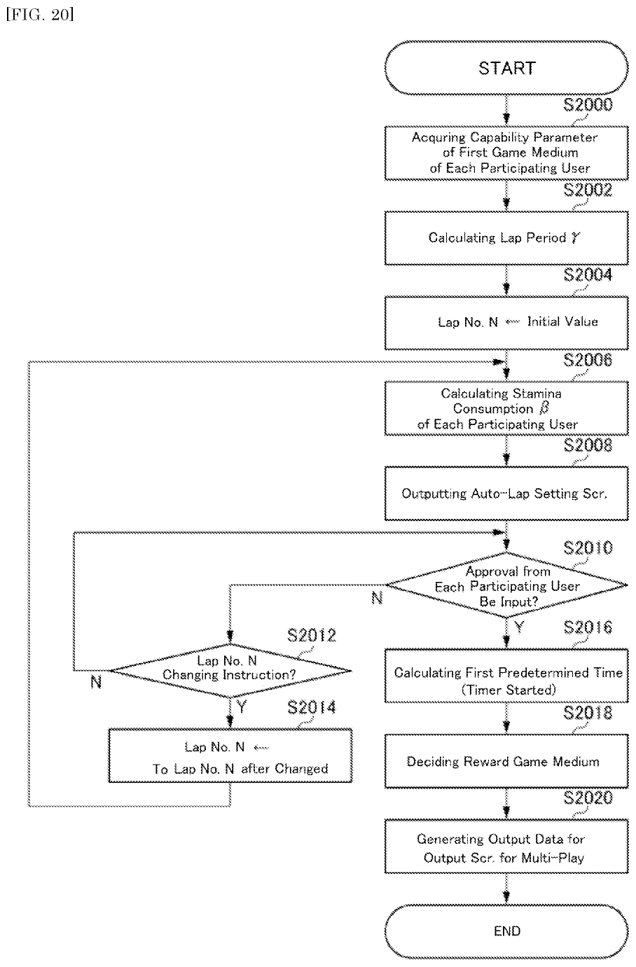

An operational example of the game system 1 is described later, but here, as an example, the operation of the server device 10 and the terminal device 20 for executing the battle game part for single-play is specifically described. On a basis of the description regarding the operation of the server device 10 and the terminal device 20 for executing the battle game part for single-play, the operation of the server device 10 and the terminal device 20 for executing the battle game part for multi-play is described later with reference to FIG. 19 and the following figures in the operational example of the game system 1.

The terminal control unit 25 determines an upper limit value (e.g., 1000 points) of the total HP of the users used for processing of the battle game part.

The terminal control unit 25 transmits an execution request for the battle game part to the server device 10, for example, depending on a user operation. When the server control unit 13 receives the execution request from the terminal device 20, the server control unit 13 may transmit the information used for executing the battle game part to the terminal device 20. The server control unit 13 and the terminal control unit 25 start the battle game part. The battle game part is executed using one or more first game medium(a) included in the deck, a second game medium arranged in the virtual space, and one or more game medium(a) being the opponent(s).

The operation of the terminal control unit 25 advancing the battle game part is described. When the battle game part has started, the terminal control unit 25 sets the action point of the opponent to an initial value (e.g., zero point).

During the execution of the battle game part, for example, a first period and a second period occur alternately and repeatedly.

The first period is, for example, a period in which the action point of the opponent is increased with time-elapsing from the initial value (e.g., zero point) to the upper limit value (e.g., 100 points). Specifically, the terminal control unit 25 starts a process (an increment processing) of increasing the action point of the opponent with time-elapsing. The starting timing of the increment processing corresponds to the starting timing of the first period. When the action point of the opponent reaches the upper limit value (e.g., 100 points), the terminal control unit 25 finishes the increment processing. The finishing timing of the increment processing corresponds to the finishing timing of the first period.

The second period is a period from the finishing timing of the first period to the timing when the action point of the opponent is reset to the initial value. Specifically, after the start of the second period, the terminal control unit 25 causes the opponent to execute a predetermined action (e.g., an attack against the user). In addition, the action point of the opponent is decreased by executing the predetermined action. Further, when the first game medium included in the deck is not allowed to execute an action (e.g., an attack against the opponent), the terminal control unit 25 may cause the opponent to execute the predetermined action, for example, immediately after the start of the second period. On the other hand, when causing the first game medium included in the deck to execute an action, the terminal control unit 25 waits for the finishing of the action by the first game medium included in the deck, and then, may cause the opponent to execute the predetermined action. In such a case, the action by the opponent is executed after the action by the first game medium included in the deck has finished. In this way, the first period and the second period occur alternately and repeatedly.

The terminal control unit 25 may cause the first game medium included in the deck to execute a predetermined action (e.g., an offense on the opponent). Specifically, in the first period, the terminal control unit 25 may make a predetermined item appeared in the virtual space. The terminal control unit 25 increases the action point of the first game medium depending on acquisition of the item by the second game medium. In a case where the action point of the first game medium is equal to or higher than a predetermined reference value, the terminal control unit 25 causes the first game medium to execute a predetermined action (e.g., an attack against the opponent), and makes the action point decreased by the predetermined reference value. The terminal control unit 25 causes the first game medium to repeatedly execute the predetermined action until the action point of the first game medium becomes less than the reference value. When the action point of the first game medium is decreased to less than the reference value, the action by the first game medium finishes.

FTG. 5 shows an example of a play screen displayed on the terminal device 20 during the execution of the battle game part. For example, a part of a two-dimensional virtual space is displayed on the play screen. Specifically, various objects arranged in the virtual space are able to be displayed on the play screen. Examples of the various objects include a moving object 40, a road surface 41, an item 42, and a leader 43 (Character A1), an opponent 44 and a development item 46 among the first game media included in the deck.

The moving object 40 corresponds to the second game medium such as a motorcycle, a car, or a person. The terminal control unit 25 automatically moves the moving object 40 in the virtual space toward a predetermined direction in the virtual space (e.g., to the right direction of the screen). In the present disclosure, the terminal control unit 25 moves the road surface 41 and the item 42 to make scrolled toward the left direction of the screen without changing the position of the moving object 40 in the left-right direction of the screen. In this way, the moving object 40 being automatically moved in the virtual space is represented. The terminal control unit 25 may make the objects such as the road surface 41 and the item 42 to sequentially appear in the traveling direction of the moving object 40 in the virtual space as the screen is scrolled. The terminal control unit 25 may make changed algorithm of the processing for causing the objects to appear between the first period and the second period.

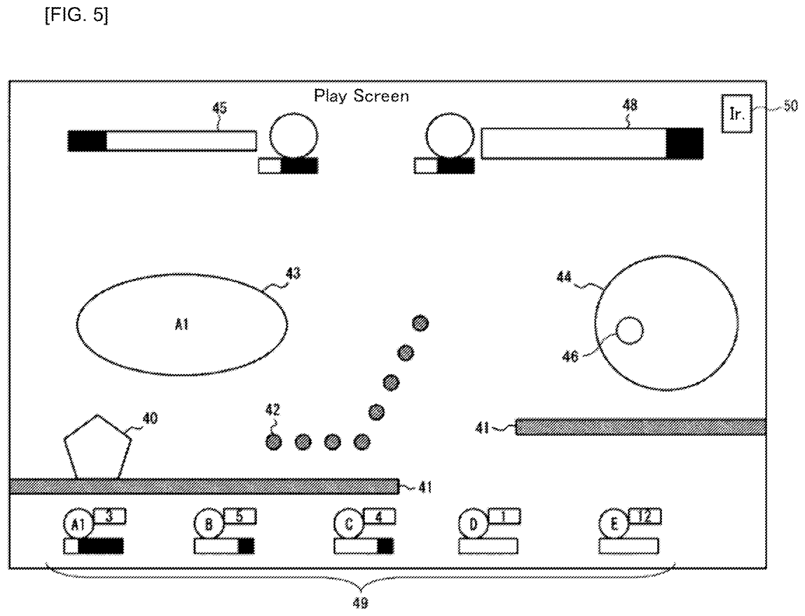

The moving object 40 is travelable on the road surface 41. The terminal control unit 25 may make the road surface 41 appear in the virtual space. The terminal control unit 25 may interrupt the road surface 41 in the first period, for example, shown in FIG. 5. On the other hand, the terminal control unit 25 may decrease an appearance number or an appearance frequency of the place where the road surface 41 is interrupted in the second period. For example, the terminal control unit 25 may set the appearance number or the appearance frequency of the place where the road surface 41 is interrupted to zero in the second period. In such a case, the road surface 41 is controlled so as not to be interrupted.

The terminal control unit 25 may make the item 42 appear in the virtual space in the first period. On the other hand, the terminal control unit 25 may make decreased the appearance number or the appearance frequency of the item 42 in the second period. For example, the terminal control unit 25 may set the appearance number or the appearance frequency of the item 42 to zero in the second period. In such a case, the item 42 is controlled so as not to appear. When the moving object 40 and the item 42 becomes overlapped on the screen, the terminal control unit 25 determines that the item 42 has been acquired. In the present disclosure, the item 42 includes an attribute item and a recovery item.

The attribute item corresponds to at least one of the first attributes of the game medium. For example, when an item corresponding to the fire attribute is acquired, the terminal control unit 25 increases the action point of each of the first game media with the fire attribute among the first game media included in the deck. When the action point of the first game medium becomes equal to or higher than a predetermined reference value, the terminal control unit 25 causes the first game medium to automatically execute a predetermined action (e.g., an attack against the opponent). For example, when the first game medium is made to execute an attack against the opponent, the terminal control unit 25 decreases the HP of the game medium being the opponent. In addition, the terminal control unit 25 deceases the action point of the first game medium having attacked by the reference value. For example, when the action point of the first game medium is 350 points and the reference value is 100 points, the terminal control unit 25 causes the first game medium to perform an attack three times in total. Then, the terminal control unit 25 decreases the action point of the first game medium by the reference value (100 points)×3 times=300 points. Therefore, after performing the attack three times, the action point of the first game medium becomes 50 points=350 points−300 points.

On the other hand, when the recovery item is acquired, the terminal control unit 25 increases the total HP of the users according to the total recovery power of the users.

The terminal control unit 25 causes the moving object 40 to jump, for example, toward the upper direction of the screen depending on a user operation on the terminal device 20. For example, the user can prevent the moving object 40 falling from the road surface 41 by having the moving object 40 jumped over a place where the road surface 41 is interrupted. When the moving object 40 falls from the road surface 41, the terminal control unit 25 decreases, for example, the total HP of the users, and then, returns the moving object 40 onto the road surface 41. Further, for example, the user can acquire the item 42 by having the moving object 40 jumped according to the arrangement of the item 42.

When having won against the opponent 44, the terminal control unit 25 disappears the display of the opponent 44 and performs presentation where the development item 46 held by the opponent 44 has been acquired by the user. In this case, the terminal control unit 25 updates the information (see FIG. 2 and FIG. 3) about the owned game medium related to the user so that the development item 46 is newly added. In the present disclosure, the development item 46 is able to function as the reinforcing material game medium as described above.

In FIG. 5, an image area 45 is an area for displaying the rest of the total HP with a gauge, an image area 48 is an area for displaying the rest of the opponent's HP with a gauge, and an image area 49 is an area which shows a state of each first game medium included in a deck. The state of the first game medium may include a state of execution propriety of a next action (an attack against the opponent, activation of a skill, etc.) changeable depending on an acquiring mode of the item 42, but detailed description thereof is omitted here.

When a predetermined user operation on the first game medium having met a predetermined activation condition is detected, the terminal control unit 25 produces a game effect corresponding to the game function set in the first game medium. The predetermined activation condition may include a condition that the predetermined parameter of the corresponding first game medium is decreased to a predetermined value (e.g., zero). Hereinafter, the predetermined parameter is also referred to as a “skill turning number”. The initial value of the skill turning number is 1 (one) point or more. The initial value of the skill turning number may be predetermined according to the game function of the first game medium. The terminal control unit 25 makes decrement of the skill turning number of the first game medium each time the first game medium executes a predetermined action (e.g., an attack against the opponent). When the game effect is produced, the terminal control unit 25 returns the skill turning number of the first game medium to the initial value.

### (Advancing Game Part)

Next, the advancing game part as described above is described in detail.

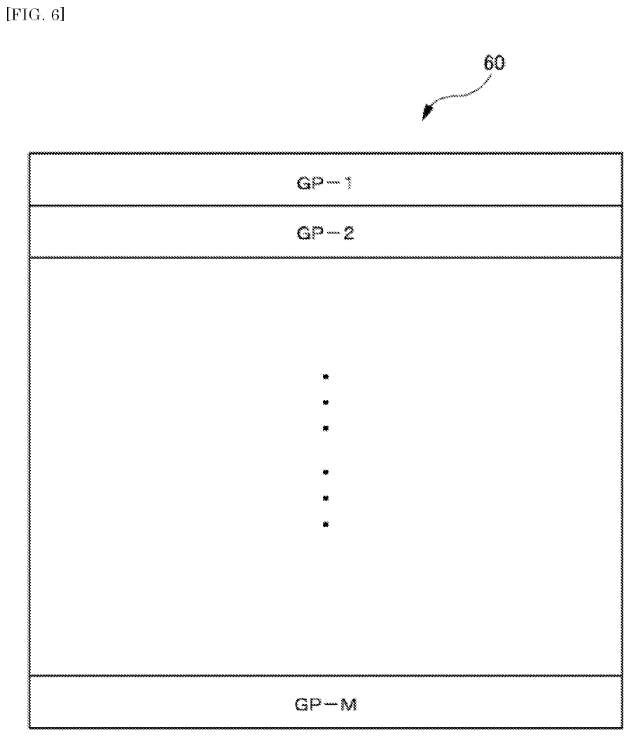

FIG. 6 is an explanatory diagram of the configuration of the advancing game part 60. In an example shown in FIG. 6, the advancing game part 60 includes M battle game parts GP-1 to GP-M. The battle game parts GP-1 to GP-M are executable in order from the battle game part GP-1, and the battle game part GP-M is executable last. That is, the user plays the advancing game part so that the user has cleared the battle game part GP-1 and can play next the battle game part GP-2, and has cleared the battle game part GP-2 and can play next the battle game part GP-3. Then, when the battle game part GP-M is cleared, the advancing game part is cleared (terminates).

The battle game parts GP-1 to GP-M are higher in difficulty level as it approaches to the battle game part GP-M, and the battle game part GP-M may be the highest in difficulty level. As described above, the details of each of the battle game parts GP-1 to GP-M are optionally set. Further, the advancing game part 60 may include a game part (e.g., a non-battle bonus game part) in a type different from the battle game part.

The battle game parts GP-k (k is any integer from 1 to M) are clearable respectively and independently of each other. Each of the battle game parts GP-k (k is any integer from 1 to M) terminate when a predetermined terminating condition is met. The predetermined terminating condition is optionally set, and, for example, when the battle game parts GP-k have been cleared by meeting a clear condition of the battle game parts GP-k (k is any integer from 1 to M), when the total HP of each deck have become to 0 (zero), when the elapsing time from the start of the game has reached a predetermined time, the predetermined terminating condition may be met.

Hereinafter, when representing any one of the M battle game parts GP-1 to GP-M, it is also simply referred to as “one battle game part GP”. Further, “for each battle game part GP-m” is used to mean for the battle game part GP-m with a different “m”.

In the present disclosure, as an example, regarding a deck in which one battle game part GP can start, two or more predetermined decks only are settable, and one deck is switched to a next one deck, when the total HP of the one deck becomes 0 (zero). Then, in playing the one battle game part GP, when the total HP of all the decks becomes 0 (zero) by the time the one battle game part GP is cleared, the one battle game part GP terminates without being cleared. When the one battle game part GP terminates without being cleared, it becomes impossible to be continued from the game state at the termination (that is, the game state is reset). Therefore, in this case, when the user plays the advancing game part again, the user does play again from the beginning of the one battle game part GP. However, in a modification, the one battle game part GP may be able to be continued under a predetermined continuation condition (e.g., consumption of a particular game medium).

In the present disclosure, the user who has cleared up to the battle game part GP-k (k is any integer from 1 to M) can play next battle game part GP-k+1 on condition that consumed is a predetermined amount a of stamina (an example of the game medium). Further, the user who has cleared up to the battle game part GP-k (k is any integer from 1 to M) can re-play any battle game part GP-m (in is any integer from 1 to k) or a particular battle game part among the battle game parts GP-1 to GP-k.

The predetermined amount a may be constant or may be set for each of the battle game parts GP-1 to GP-M. Except for an automatic lap of the battle game part GP-m, which is described later, the user can advance the battle game part GP-m during play by giving an operation input (a first operation input) in principle. Hereinafter, the battle game part that is advanced by giving the operation input in this way is also referred to as a “manual-play battle game part”.

Further, in the present disclosure, the user can play automatically the one battle game part GP-m N times in succession on condition that canceled (consumed) is stamina (an example of a consuming game medium) for a stamina consumption amount β associated with the user when a predetermined start condition is met for the one battle game part GP-m. N is a positive integer, and may be a fixed value or may be settable by the user. “Automatically” refers to a mode in which operation advances without basically requiring operation input from the user. For example, the operation input from the user may include two of starting/terminating, or only one of starting. Hereinafter, the mode in which the one battle game part GP-m is automatically played N times in succession is also referred to as an “automatic lap of the battle game part GP-m”. Further, “N times” is also referred to as a “number-of-laps N”.

The stamina consumption amount β may be set in such a manner that the greater the number-of-laps N, the greater the stamina consumption amount β becomes. In other words, the number-of-laps N may be set in such a manner that the greater the stamina consumption amount β, the greater the number-of-laps N becomes. In this case, the number-of-laps N may have the upper limit in a finite value or the upper limit in infinity. When the number-of-laps N has the upper limit in a finite value, the finite value may be set based on the information about the user and/or the information about the in-game game medium (see FIG. 2 and FIG. 3). For example, the finite value may be set higher for a user with a relatively high rank than for a user with a relatively low rank. Further, the finite value may be set higher in a case where the value of the capability parameter of the in-use game medium is relatively higher than in a case where it is relatively lower. However, the upper limit of the stamina consumption amount β settable for one user is determined depending on the value of stamina associated with the one user. Note that, for the stamina consumption amount β associated with the automatic lap of the battle game part GP-m, an amount per lap, namely, the stamina consumption amount per lap (=β/N) may be the same as or different from the predetermined amount a required for the manual-play battle game part GP-m. Further, the stamina consumption amount β may be different for each user in such a manner that it is different depending on, for example, the first game medium. Further, any unit of stamina is employable, and may be a number such as an amount corresponding to energy or the number of items related to stamina.

Further, in the present disclosure, the stamina is set in one type only, but may be prepared in a plurality of types. In this case, the stamina consumption amount β may be set so that the number-of-laps N per unit consumption amount is greater in a case where a first type stamina is consumed than in a case where a second type stamina is consumed.

The user can obtain a game medium for reward associated with the battle game part GP-m by performing the automatic lap of the battle game part GP-m. In the following, for the sake of distinction, the game medium for reward obtained by the user performing the automatic lap of the battle game part GP-m is also referred to as a “game medium for reward”. The game medium for reward related to the battle game part GP-m may be set for each battle game part GP-m. Further, in the automatic lap of the battle game part GP-m, the game medium for reward may be set for each lap. For example, in a case of the automatic laps of the battle game part GP-m in the number-of-laps N, the game medium for reward may be set for each battle game part GP-m in the number-of-laps N. The game medium for reward associated with the battle game part GP-m does not have to be constant and may be changed randomly or according to a predetermined rule. Further, the game medium for reward associated with the battle game part GP-m may be selectable by the user from a plurality of candidates. Alternatively, the game medium for reward associated with the battle game part GP-m may be selected by lottery from a plurality of candidates.

The game medium for reward is optionally set, but it may be a game medium that enables or facilitates clearing of the battle game part itself and/or various missions with respect to a part or all of the battle game part GP-k+1 to the battle game part GP-M. For example, the game medium for reward associated with the battle game part GP-m may be an item that can be effectively used in the battle game part GP-k+1 to be next cleared by the user (an item for easy clearance, etc.).

Further, the game medium for reward may be set for each user. In this case, the game medium for reward may be determined to include a game medium that enables or facilitates clearing of a predetermined mission having not yet been cleared by the user. Further, the game medium for reward may include a special game medium caused by an event or the like.

As described above, in the present disclosure, the automatic lap of the battle game part GP-m is a play mode that is useful for the user in acquiring the game medium for reward to efficiently advance the advancing game part.

Note that, in the present disclosure, the battle game part GP-m related to the automatic lap is one of the battle game parts GP-1 to GP-M, but it may be prepared as a dedicated game part separately from the battle game parts GP-1 to GP-M. Further, the battle game part GP-m related to the automatic lap does not have to be strictly the same as one corresponding game part among the battle game parts GP-1 to GP-M, like a simplified version of one corresponding game part among them.

By the way, as described above, while the automatic lap of the battle game part GP-m is useful for the user, but it has a drawback that it takes relatively long binding time. That is, since the automatic lap of the battle game part GP-m is an automatic play, while the user can save his/her trouble, the user cannot do other work on the same terminal device 20 over the entire game time related to the automatic lap of the battle game part GP-m, and this may be possibly inconvenient for the user. Further, even if the automatic lap of the battle game part GP-m can be interrupted for other work, the user have to restart after interruption, and interruption itself is complicated besides. Such complexity becomes possibly a factor in avoiding the automatic lap for a relatively long time (a relatively large number-of-laps N). Further, the automatic lap of the battle game part GP-m becomes possibly a relatively monotonous advancing mode, and the user has also relatively limited interest in the advancing mode thereof (that is, the user has main interest in the game medium for reward). As a result, it becomes difficult for the user to easily start the advancing game part, opportunities to play the advancing game part are decreased, and the advancing game part might be halved in attractiveness.

In particular, in a case where the automatic lap of the battle game part GP-m is executed in such a manner that it reproduces actual play as performed, while it is possible to visually show advancing status of the automatic lap to the user, a processing load becomes high and it is difficult, until the automatic lap is completed, to execute in parallel new processing (e.g., processing related to advancing of the out-game part) that brings a high processing load.

Therefore, in the present disclosure, the processing related to the automatic lap of the battle game part GP-m is executed in a significantly shorter time than a first predetermined time as described later. That is, the processing related to the automatic lap of the battle game part GP-m is simplified so that the time significantly occupied by the hardware resources for the processing related to the automatic lap of the battle game part GP-m becomes significantly shorter than the first predetermined time.

For example, the processing related to the automatic lap of the battle game part GP-m includes, depending on the value of the parameters such as the number-of-laps or the lap time related to the automatic lap of the battle game part GP-m, processing of determining the game medium for reward and the stamina consumption amount β only and processing of outputting the result of the automatic lap, and is realized by omitting processing of reproducing the actual battle. That is, in the present disclosure, processing of updating and displaying automatic advancing status at high speed and in real time is eliminated, and processing of generating and outputting the result only is substantially performed.

Thus, it becomes possible to significantly reduce the processing load related to the automatic lap of the battle game part GP-m. As a result, the user is released from the automatic lap of the battle game part GP-m from the start of the automatic lap of the battle game part G-P-m until the result becomes outputtable, and it becomes also possible to increase the operational flexibility of the user.

Specifically, in the present disclosure, in the automatic lap of the battle game part GP-m, the result becomes outputtable after elapsing of the first predetermined time, and a first predetermined user's input becomes acceptable until the first predetermined time elapses.

The first predetermined time is a time parameter that sets a time length. Further, the first predetermined time is a time parameter associated with the automatic lap of the battle game part GP-m and is set as appropriate. The first predetermined time may correspond to play time in average required for the manual-play battle game part GP-m, or it may be set independently from play time in average required for the manual-play battle game part GP-m.

The first predetermined time may be set in such a manner that the greater the number-of-laps N, the longer the first predetermined time becomes. This is to be matched with a case of the manual-play battle game part GP-m. That is, since the play time becomes longer as the number of plays (the number of clearances) increases in a case of the manual-play battle game part GP-m, following to this, the first predetermined time may be set longer as the number-of-laps N increases in a case of the automatic lap of the battle game part GP-m. Further, the first predetermined time may be changed depending on other parameters (e.g., various parameters related to the first game medium) as described later.

The first predetermined user's input includes at least one input of an input for starting and advancing a game part related to an out-game, an input for making non-displayed the game screen for displaying the advancing game part 60, and an input for starting or performing an application different from the present game application.

In this case, the game part related to an out-game may be a game part related to an out-game executable by the present game application, or a game part related to an out-game executable by a game application other than the present game application.

Further, the input for making non-displayed the game screen for displaying the advancing game part 60 may include an input for transferring the game screen for displaying the advancing game part 60 to the background (in a non-active state impossible to input a command) on the terminal device 20 and an input for deleting the game screen itself for displaying the advancing game part 60 (an input for realizing a so-called “task kill”).

Further, the application different from the present game application may be any application other than the present game application, and may differ for each user. For example, in a case where various other applications are installed in the terminal device 20 related to one user in addition to the present game application, any application different from the present game application for the terminal device 20 related to the one user corresponds to these other various applications that are executable by the terminal device 20.

Therefore, in the present disclosure, the user can proceed with various operations (that is, various operations involving the first predetermined user's input) while waiting for the output of the result of the automatic lap of the battle game part GP-m until the first predetermined time elapses. Accordingly, since the user can perform various operations (that is, various operations involving the first predetermined user's input) even if the first predetermined time is relatively long, it is more likely that the time length of the first predetermined time like this is allowable for the user.

Note that the first predetermined user's input may be acceptable even after the first predetermined time has elapsed (that is, after the result of the automatic lap of the battle game part GP-m has become outputtable), and in this case, the first predetermined user's input may be acceptable without any special condition after first predetermined time has elapsed. Similarly, the first predetermined user's input may be acceptable even before the first predetermined time has started to be counted (that is, before the automatic lap of the battle game part GP-m has started), and in this case, the first predetermined user's input may be acceptable without any special condition.

In the present disclosure, the first predetermined user's input until the first predetermined time elapses is acceptable and may be with no condition. In the present disclosure, the first predetermined user's input until the first predetermined time elapses is acceptable in such a manner that the first predetermined user's input does not affect the first predetermined time.

Of the first predetermined time, the time (hereinafter also referred to as “second predetermined time”) during which the first predetermined user's input is acceptable in such a manner that it does not affect the first predetermined time is at least a part of the first predetermined time. In the present disclosure, the first predetermined time and the second predetermined time start from the same time point and have the same time length. Therefore, in the present disclosure, the automatic lap of the battle game part GP-m over the first predetermined time is realized in such a manner that the first predetermined user's input acceptable over the first predetermined time. However, in a modification, the second predetermined time may start slightly late just after the start of the first predetermined time and end just before the end of the first predetermined time.

A mode in which the first predetermined user's input does not affect the first predetermined time is a concept including a mode in which the time length of the first predetermined time is not changed significantly due directly to the first predetermined user's input (and accordingly, a mode in which the game medium for reward and the stamina consumption amount β are not changed). That is, a mode in which the time length of the first predetermined time is changed significantly due directly to the first predetermined user's input corresponds to a mode in which the first predetermined user's input affects the first predetermined time. For example, in a case where the automatic lap of the battle game part GP-in is the advancement repeatedly N times of the battle game part GP-m (an example of a predetermined advancement), the first predetermined user's input until the first predetermined time elapses is acceptable in such a manner that the advancement repeatedly N times is maintained (e.g., a mode in which N times are not reduced).

Therefore, even if the user performs the first predetermined user's input before the first predetermined time elapses, no concept of “restart (restart related to the automatic lap of the battle game part GP-m)” is brought to the user, the user obtains the output of the result of the automatic lap of the battle game part GP-m after the first predetermined time has elapsed. That is, regardless of whether or not the user performs the first predetermined user's input before the first predetermined time elapses, the user can obtain the output of the result of the automatic laps of the battle game part GP-m after the first predetermined time has elapsed.

In this way, according to the present disclosure, by making acceptable the first predetermined user's input in such a manner that it does not affect the first predetermined time, it is easy for the user to execute the automatic lap of the battle game part GP-m. As a result, the user can freely start the automatic lap of the battle game part GP-m, and opportunities to play the advancing game part 60 are increased. Accordingly, it is possible to increase the number of the users who play the advancing game part 60, and improve the activity of the advancing game part 60.

### (Specific Example of Automatic Lap Function)

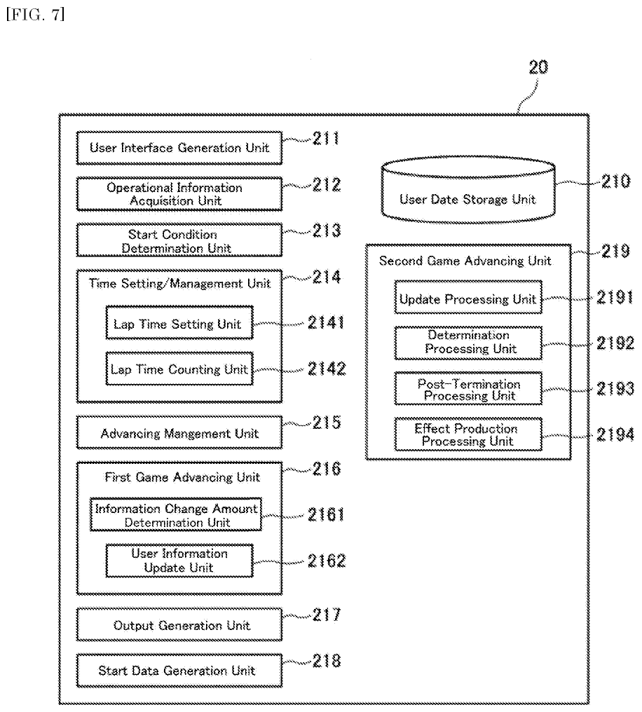

Next, with reference to FIG. 7 and the following figures, a function related to the automatic lap of the battle game part GP-m is further described.

FIG. 7 is a block diagram showing a function related to the automatic lap of the battle game part GP-m (hereinafter also referred to as an “automatic lap function”) among various functions of the terminal device 20.

A function related to one terminal device 20 is described below, but the same applies to the other terminal devices 20. The one terminal device 20 described below is a terminal mainly used by a user having particular one user ID (hereinafter also referred to as a “user of the terminal device 20” or merely a “user”).

The terminal device 20 includes a user data storage unit 210, a user interface generation unit 211, an operational information acquisition unit 212, a start condition determination unit 213 (an example of a condition determination unit), a time setting/management unit 214, an advancing management unit 215, a first game advancing unit 216, an output generation unit 217, a start data generation unit 218, and a second game advancing unit 219.

The user data storage unit 210 can be realized by the terminal storage unit 22 (see FIG. 1) of the terminal device 20. Further, each processing unit from the operational information acquisition unit 212 to the second game advancing unit 219 can be realized by executing the game application stored in the terminal storage unit 22 with the terminal control unit 25 (see FIG. 1) of the terminal device 20.

The user data storage unit 210 stores information related to user data associated with the user of the terminal device 20 (hereinafter also referred to as “user data”) as described above. The user data is data used in the game entirely. The user data includes the information about the owned game medium (see FIG. 3).

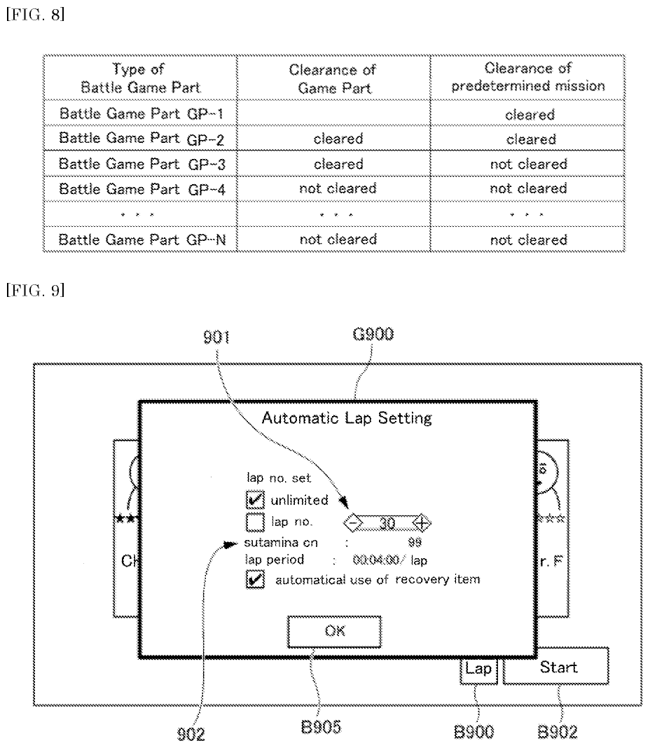

Further, in the present disclosure, the user data further includes information about the advancing status of the advancing game part (hereinafter also referred to as “advancing information”) as information related to the automatic lap function. FIG. 8 shows an example of the advancing information associated with one user. In an example shown in FIG. 8, for each of the battle game parts GP-k (k=1 to M), information about whether or not the game part is cleared and whether or not the predetermined mission is cleared (completed) are shown as the advancing information. The predetermined mission is optionally set, and may be, for example, acquiring of a predetermined item. The predetermined mission may be set for each of the battle game parts GP-m, or may be common to a part or all of m battle game parts GP-m.

Note that, in an example shown in FIG. 8, the user has cleared the battle game part GP-1 to the battle game part GP-3, and also, has cleared the predetermined mission in the battle game parts GP-1 and GP-2 among them, respectively. Therefore, the user can play the battle game part GP-4 to clear it, and also, can replay (manually replay) the battle game part GP-3 to clear the predetermined mission in the battle game part GP-3.

The user interface generation unit 211 generates various user interfaces for generating various user's inputs. The user interface related to the automatic lap function is described later with reference to FIG. 9 and other figures.

The operational information acquisition unit 212 acquires information according to user's input on the terminal device 20 (hereinafter also referred to as “user's input information”). In a case of touch operation, the user's input information may be information representing a touch operation position and a touch operation type (e.g., a tap operation, a flick operation, etc.) on the display unit 23 of the terminal device 20. Tn the present disclosure, for example, the user can perform various user's inputs via various user interfaces generated by the user interface generation unit 211.

The start condition determination unit 213 determines whether or not the predetermined start condition for the automatic lap of the battle game part GP-m is met. The “m” of the battle game part GP-m as the target of the automatic lap may be less than M. That is, the final battle game part GP-M may be excluded from the target of the automatic lap. Alternatively, of each of the battle game parts GP-k (k=1 to M), the battle game part GP-m as the target of the automatic lap may be further limited as appropriate.

The predetermined start condition may be set for each battle game part GP-m, or may be common to a part or all of m battle game parts GP-m. In a case of setting for each battle game part GP-m, the predetermined start condition may be set in such a manner that the greater the “m” of the battle game part GP-m (that is, the closer it is to M), the more difficult it is to be set.

Further, the predetermined start condition may be set based on the information about the user and/or the information about the in-use game medium (see FIG. 2 and FIG. 3). For example, the predetermined start condition may be set looser for a user having a relatively high rank than for a user having a relatively low rank. Further, the predetermined start condition may be set looser in a case where the value of the capability parameter of the in-use game medium is relatively higher than in a case where it is relatively lower.

In the present disclosure, as an example, the predetermined start condition related to one battle game part GP-m is established based on the logical conjunction (AND) with a condition element K1 and a condition element K2 as follows.

### (Condition Element K1)

The condition element K1 is a condition element in conjunction of that the stamina more than the stamina consumption amount β is associated with the user, AND, that a lap start input from the user (an example of user's input) is acquired on condition that the stamina (an example of a consuming game medium) corresponding to the stamina consumption amount β associated with the user is canceled.

### (Condition Element K2)

The condition element K2 is a condition element in conjunction of that the manual-play battle game part GP-m is cleared, AND, that the predetermined mission associated with the manual-play battle game part GP-m is cleared. Here, regarding the condition element Kl, the lap start input from the user is generated by operating a start button B902 on a deck formation screen G1000 (see FIG. 10) after inputting various settings on the automatic lap setting screen G900 (see FIG. 9). An automatic lap button B900 (see FIG. 10) for realizing screen transition to the automatic lap setting screen G900 (see FIG. 9) may be operable when the condition element K2 is met. That is, the automatic lap button B900 (see FIG. 10) may be changed from an inactive state to an operable active state when the condition element K2 is met.

For example, with respect to the user shown in FIG. 8, as described above, the information (an example of a first information) indicating that the user has cleared the battle game part GP-1 to the battle game part GP-3 are associated with him/her, and also, the information (an example of a second information) indicating that the user has cleared the predetermined missions in the battle game parts GP-1 and GP-2 among them, respectively, is associated with him/her. Therefore, the user satisfies the condition element K2 for the battle game parts GP-1 and GP-2.

Here, the predetermined start condition related to one battle game part GP-in may be in diverse way and is not limited to the above-mentioned conditions. For example, the conditional element K2 may be replaced with a conditional element K2-1, a conditional element K2-3, or the like as described later. Alternatively, with respect to the predetermined start condition, the conditional element K2 may be utilized in a form of the logical conjunction (AND) or the logical disjunction (OR) with the conditional element K2-1 and the conditional element K2-3.

(Condition element K2-1)

The condition element K2-1 is a condition element that a particular game function (an example of a game medium) such as a particular skill is associated with the user TD.

(Condition element K2-3)

The condition element K2-3 is a condition element that the value of a particular capability parameter (an example of a predetermined first game parameter) associated with the first game medium meets a predetermined reference. In a case of the condition element K2-3, the particular capability parameter is optionally set and may be, for example, the HP, etc. Further, the value of the particular capability parameter may be evaluated by a total value, an average value, a maximum value, or the like of the value of each particular capability parameter of the plurality of first game media. Further, as described above, the predetermined reference may be set for each battle game part GP-m to have a different reference value for each battle game part GP-m (an example of the value of the predetermined second game parameter). In this case, the predetermined reference may be set in such a manner that the greater the “m” of the battle game part GP-m (that is, the closer it is to M), the more difficult it is to be set. Alternatively, the predetermined reference may have a common reference value (an example of the value of the predetermined second game parameter) to a part or all of the m battle game parts GP-m.

Further, a conditional element K3 peculiar to the battle game part GP-m may be further considered. The condition element K3 may be, for example, as follows.

### (Condition Element K3)

The condition element K3 is a condition element that a remaining Lime until the end of the playable period of the battle game part GP-m is more than a predetermined time T0. The conditional element K3 as such is suitable in a case where the battle game part GP-m is in a form of a quest during a limited period. The predetermined time T0 may be set in a mode longer than the first predetermined time as described above. In other words, the first predetermined time may be set so as not to exceed the predetermined time T0. The playable period may correspond to, for example, a predetermined holding period of an event or the like.

The time setting/management unit 214 sets and manages various times related to the automatic lap function. In the present disclosure, the time setting management unit 214 includes a lap time setting unit 2141 (an example of a parameter determination unit) and a lap time clocking unit 2142 (an example of a count control unit).

The lap time setting unit 2141 sets (initially sets) a length of the first predetermined time as described above, which is the lap time, based on a setting input associated with the user. The setting input may be inputtable via the user interface (e.g., the automatic lap setting screen G900 shown in FIG. 9) generated by the user interface generation unit 211. FIG. 9 shows an example of the automatic lap setting screen G900 that functions as a setting screen for the automatic lap. In this case, the user sets the length of the first predetermined time as described above, which is the lap time, by setting the value of the number-of-laps N. In this case, the lap time setting unit 2141 may be increased in the length of the first predetermined time as the value of the number-of-laps N is increased. For example, assuming that the time required for one lap is γ [minutes], it may be calculated as the length of the first predetermined time: the length=∛×N. The time γ required for one lap (hereinafter also referred to as a “lap period γ”) may be changed, when a predetermined game condition is changed, according to such change. The predetermined game conditions relate to advancing status of the automatic game, types of the first game medium, elements of the first game medium, use of items, and the like. The elements of the first game medium are, for example, a parameter that affects the lap period γ, and the parameter may be a growth parameter changeable of the value during another game part such as an out-game part or during the automatic lap of the battle game part GP-m. In this case, the lap period γ may be set based on the information about the user and/or the information about the in-use game medium (see FIG. 2 and FIG. 3). For example, the lap period γ may be changed according to the value of the capability parameter associated with the first game medium, may be changed according to the stator information associated with the user, may be shortened by consuming a predetermined shortened item, or may be changed for each battle game part GP-m to be lapped. In this case, the lap period γ may be set in such a manner that the lager the “m” of the battle game part GP-m (that is, the closer it is to M), the longer it becomes. Alternatively, the lap period γ may be common to a part or all of the m battle game parts GP-m.

Note that, the automatic lap setting screen G900 shown in FIG. 9 includes a display 901 indicating the number-of-laps and a display 902 indicating the stamina consumption amount β to be planned to be consumed. The display 901 indicating the number-of-laps may include a button for increasing or decreasing the number-of-laps. As described above, the stamina consumption amount β may be increased depending on the length of the lap time and the number-of-laps. Therefore, the stamina consumption amount β may be set by the lap time setting unit 2141 in such a manner that it is linked to the length of the first predetermined time. The automatic lap setting screen G900 may include the necessity of automatic use of a recovery item as another setting during the automatic lap.

In the present disclosure, the lap time setting unit 2141 shortens the first predetermined time as initially set in a case where a predetermined first shortening condition is met by the time when the first predetermined time elapses. The predetermined first shortening condition is optionally set, but in the present disclosure, it is met based on a first operation input or a second predetermined user's input as described later.

In the present disclosure, the lap time setting unit 2141 may shorten the first predetermined time by shortening the lap period γ in a case where the predetermined second shortening condition is met. The predetermined second shortening condition may be a condition that is met before the start button B902 is operated. For example, the predetermined second shortening condition may be met by consuming a particular game medium for speeding up.

The lap time clocking unit 2142 clocks the first predetermined time. That is, the lap time clocking unit 2142 detects the elapse of the first predetermined time. The clocking of the first predetermined time may be realized by an internal timer or the like, or may be realized by using time information (GPS time or the like). Note that, equivalently, the lap time clocking unit 2142 may detect an event that occurs at the same timing as the first predetermined time (e.g., arrival of the number-of-laps N as described later) instead of clocking the first predetermined time.

Tn the present disclosure, the lap time clocking unit 2142 starts counting the elapsing time (an example of the count value of the first parameter) (hereinafter also referred to as an “automatic lap time”) in a case where the predetermined start condition is met, and detect the timing at which the automatic lap time becomes the first predetermined time (an example of the setting value of the first parameter), that is, the timing at which the difference between the automatic lap time and the first predetermined time becomes 0 (zero) (an example of a first threshold value) or less. Therefore, the lap time clocking unit 2142 detects the elapsing of the first predetermined time from the time when the predetermined start condition has been met. However, the time point when the predetermined start condition has been met does not have to be a strict time point, and may be a time point separated by a certain time from the time point when the predetermined start condition has been met.

Note that, in a case where the first predetermined time has been shortened by the lap time setting unit 2141, the lap time clocking unit 2142 clocks the first predetermined time as shortened without moving the start timing of clocking. In this case, the elapsing of the first predetermined time becomes accelerated.

The advancing management unit 215 is acceptable of the first predetermined user's input in such a manner that it does not affect the length of the first predetermined time until the first predetermined time elapses (that is, until the time counting of the first predetermined time by the lap time clocking unit 2142 is completed). The first predetermined user's input is as described above. Specifically, the advancing management unit 215 makes continued the operation of the lap time clocking unit 2142 so that the first predetermined time is not changed due to the first predetermined user's input even when the first predetermined user's input is generated in the terminal device 20 (that is, prohibiting the lap time clocking unit 2142 from stopping or interrupting to clock the time due to the first predetermined user's input).

The advancing management unit 215 may limit the acceptance of the first operation input for starting other game parts with the same attribute as the battle game part GP-m until the first predetermined time elapses. Other game parts with the same attribute as the battle game part GP-m (hereinafter also referred to as a “restricted game part”) are similar battle game parts, and may include the battle game part GP-k+1. Further, the restricted game part may include one or more re-playable game part(s) among the battle game parts GP-1 to GP-k. Further, the restricted game part may include other battle game parts in the present game application (e.g., the multi-play battle game part, the independent battle game part, and the like). Further, the restricted game part may include the manual-play battle game part, or may include an automatic lap of other battle game parts. Alternatively, the restricted game part may include only the battle game part when executing with using at least one of the first game media used in the automatic lap of the battle game part GP-m. In this case, for example, the battle game part GP-k+1 may be excluded from the restricted game part when playing without using the first game medium used in the automatic lap of the battle game part GP-m until the first predetermined time elapses.

In this way, it is possible to reduce the processing load while maintaining the change in the game balance within appropriate range by limiting the play of other battle game parts until the first predetermined time clocked from the start of the automatic lap of the battle game part GP-m elapses.

However, the advancing management unit 215 may accept the first operation input on condition that the first predetermined time ends. The end of the first predetermined time is an event caused by either the elapse of a predetermined time (expiration) or the shortening (interruption) of a predetermined time before the elapse of the predetermined time. Regarding the shortening (interruption) of the predetermined time before the elapse of the predetermined time, the user changes his mind and instead of waiting for the elapse of the first predetermined time, instead of the automatic lap of the battle game part GP-m, the restricted game. This is because there may be times when you want to play a part. In this case, the advancing management unit 215 may reduce or eliminate the usefulness (reward value) of the game medium for reward as described later by shortening the first predetermined time. As a result, the selective flexibility of the user can be ensured in such a manner that fairness is ensured.

Further, the advancing management unit 215 may be acceptable of a second predetermined user's input for shortening or extending the first predetermined time until the first predetermined time elapses. This is because, as in a case of the first operation input, the user may change his/her mind and desire to shorten or extend the first predetermined time. When the first predetermined time is extended or shortened, the usefulness (reward value) and the stamina consumption amount β of the game medium for reward may be increased or decreased accordingly, as described later. As a result, the selective flexibility of the user may be ensured in such a manner that fairness is ensured. In the following, the second predetermined user's input for shortening the first predetermined time is mainly described, but the second predetermined user's input for extending the first predetermined time may be the same because of becoming reversed only (that is, the usefulness (reward value) of the game medium for reward becoming reversed only from decreasing to increasing).

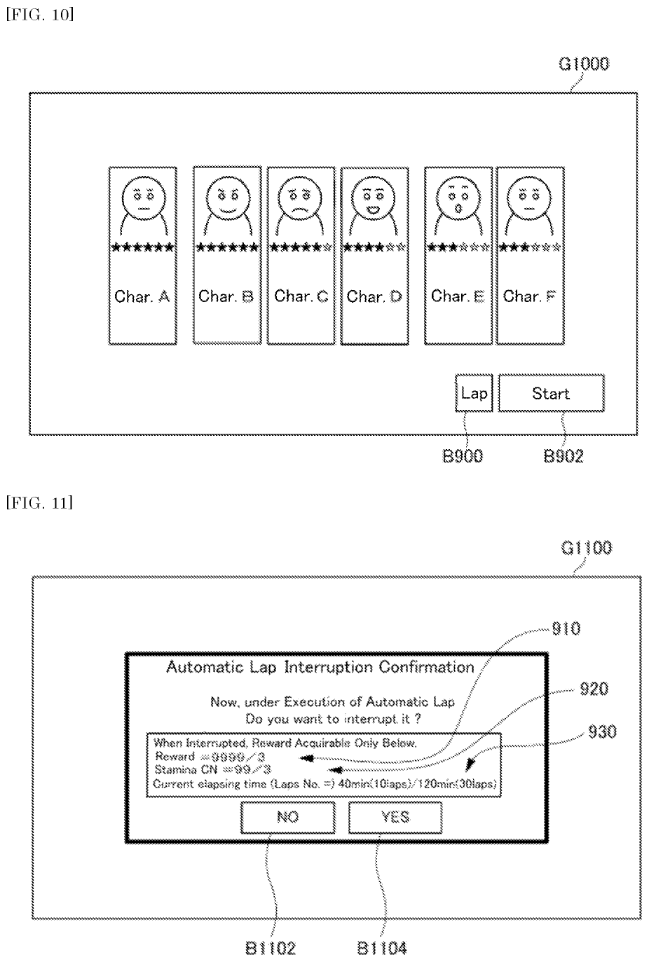

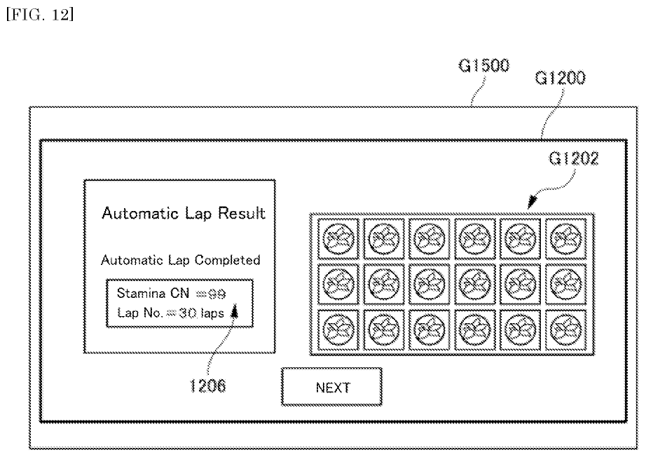

FIG. 11 shows an example of the interruption confirmation screen G1100 for accepting the second predetermined user's input. In an example shown in FIG. 11, the second predetermined user's input is generated by the user operating the interrupt button (YES-button B1104 in an example shown in FIG. 11) for the automatic lap of the battle game part GP-m. The interruption confirmation screen similar to the interruption confirmation screen G1100 may be generated (output) before accepting the above-mentioned first operation input. That is, when the user starts the restricted game part, after operating the interrupt button (that is, after performing the second predetermined user's input), the user may perform the above-mentioned first operation input (e.g., the operation of the start button B902).

The interruption confirmation screen G1100 may include the information 910 indicating a game medium for reward obtained when a second predetermined user's input is performed at the present time and the information 920 indicating an amount of stamina consumed when the second predetermined user's input is performed at the present time. In this case, the user can obtain useful judgment material as to whether or not the second predetermined user's input may be performed at the present time, and the convenience can be enhanced. However, in a modification, only the information 910 may be output or only the information 920 may be output via the interruption confirmation screen G1100. Note that, in an example shown in FIG. 11, the game medium for reward is a point, and the information 910 indicates that ⅓ of 9999 points initially planned is obtained. The information 920 indicates that ⅓ of the stamina consumption amount 6 =99 initially planned to be consumed is consumed. Further, in an example shown in FIG. 11, the interruption confirmation screen G1100 includes information 930 indicating the current automatic lap time (a part of the first predetermined time). In this case, the information 930 represents that 40 minutes out of initially scheduled 120 minutes are in advancing. Note that the information 930 may include the value of other parameters representing the current automatic lap time such as the current number-of-laps in place of or in addition to the current automatic lap time.

The first game progressing unit 216 realizes the automatic lap of the battle game part GP-m when the above-mentioned predetermined start condition is met. That is, the first game advancing unit 216 automatically realizes the advancing repeatedly N times of the battle game part GP-m (an example of a predetermined advancement). As described above, “automatic” refers to a mode in which any operation input is basically not required from the user.

In the present disclosure, the first game advancing unit 216 includes an information change amount determination unit 2161 (an example of a determination unit) and a user information update unit 2162.

The information change amount determination unit 2161 determines the game medium for reward according to the length of the first predetermined time (an example of determining the termination result). That is, the information change amount determination unit 2161 determines the game medium for reward for the automatic lap of the battle game part GP-m based on the first predetermined time or the parameter (number-of-laps N) related to the first predetermined time. The method of determining the game medium for reward is optionally set, and may be determined in the manner as described above.

In the present disclosure, as an example, the information change amount determination unit 2161 determines the game medium for reward in such a manner that the greater the number-of-laps N, the higher the usefulness (reward value) of the reward becomes. For example, in a case of a game medium for reward in which a large number increases the usefulness, the information change amount determination unit 2161 may determine a game medium for reward in such a manner that the greater the number-of-laps N, the greater the number of reward game media are increased linearly or non-linearly. Further, in a case of a game medium for reward having a rarity, the information change amount determination unit 2161 may determine the game medium for reward in such a manner that the greater the number-of-laps N, the higher the rarity of the game medium for reward becomes.

Further, when the advancing management unit 215 shortened the first predetermined time (when the lap time setting unit 2141 shortened the first predetermined time), the information change amount determination unit 2161 may determine the game medium for reward according to a predetermined time as shortened (and accordingly, the number-of-laps N reduced). However, in a modification, the information change amount determination unit 2161 may maintain the game medium for reward according to the first predetermined time before shortened under a predetermined condition (e.g consumption of a particular game medium). In this case, the predetermined condition may be set in such a manner that the longer the shortened time (equals the first predetermined time before shortened minus the first predetermined time after shortened), the stricter the predetermined condition becomes. For example, when the predetermined condition is the consumption of a particular game medium, the predetermined condition may be set to consume the particular medium greater as the shortened time becomes longer.

In addition, the information change amount determination unit 2161 determines the stamina consumption amount β according to the length of the first predetermined time (an example of determining the termination result). That is, the information change amount determination unit 2161 determines the stamina consumption amount β consumed for the automatic lap of the battle game part GP-m based on the first predetermined time or the parameter (number-of-laps N) related to the first predetermined time. The method of determining the stamina consumption amount β is optionally set and may be determined in the manner as described above.

In the present disclosure, as an example, the information change amount determination unit 2161 determines the stamina consumption amount β in such a manner that the greater the number-of-laps N, the greater the stamina consumption amount β becomes. Equivalently, the information change amount determination unit 2161 may determine the stamina consumption amount B in such a manner that the higher the usefulness (reward value) of the game medium for reward, the greater the stamina consumption amount β becomes.

Further, when the advancing management unit 215 shortened the first predetermined time (when the lap time setting unit 2141 shortened the first predetermined time), the information change amount determination unit 2161 may determine the stamina consumption amount β according to the first predetermined time as shortened (and accordingly, the number-of-laps N reduced). However, in a modification, when the advancing management unit 215 shortened the first predetermined time (when the lap time setting unit 2141 shortened the first predetermined time), the stamina consumption amount β may remain as it is, as a shortening processing fee (penalty), according to the first predetermined time before shortened.

The user information update unit 2162 updates the user information related to the automatic lap of the battle game part GP-m. Specifically, the user information update unit 2162 updates the information about the user in such a manner of associating the user with the game medium for reward and the stamina having a value reduced by the stamina consumption amount β. Note that associating the user with the stamina having a value reduced by the stamina consumption amount β is synonymous with canceling the stamina for the stamina consumption amount β having been associated with the user.

The user information update unit 2162 may update the user data related to the automatic lap of the battle game part GP-m when the output screen G1200 (see FIG. 12) of the termination result of the automatic lap of the battle game part GP-m is output, or may update such user data before the output screen G1200 (see FIG. 12) of the termination result of the automatic lap of the battle game part GP-m is output. For example, the stamina associated with one user may be reduced by the stamina consumption amount β when the start button B902 is operated. In this case, when the first predetermined time is shortened due to the interruption, a part of the reduced stamina (a part of the stamina consumption amount β) may be returned to the one user.

The output generation unit 217 may be outputtable of the termination result of the automatic lap of the battle game part GP-m when the first predetermined time has elapsed. The output generation unit 217 may output the termination result of the automatic lap of the battle game part GP-m depending on a predetermined input from the user when the first predetermined time has elapsed. Note that the output generation unit 217 may give a notification that effect when the first predetermined time has elapsed. In this case, the user may be able to make a predetermined input via the user interface included in the notification. In this case, such notification function may be turned on/off by the user. Alternatively, the output generation unit 217 may give a notification indicating that the first predetermined time has elapsed when the user displays the screen of the present game application. In this case, the user may be able to make a predetermined input via the user interface included in the notification. Alternatively, the output generation unit 217 may automatically output the termination result of the automatic lap of the battle game part GP-m when the user displays the screen of the present game application. In this case, the predetermined input corresponds to the input for the user to display the screen of the present game application.

FIG. 12 shows an example of the output screen G1200 of the termination result of the automatic lap of the battle game part GP-m. The output screen G1200 of the termination result may be in the form of a modal window output with the home screen G1500 or the like behind. The output screen G1200 of the termination result of the automatic lap of the battle game part GP-m may include the information G1202 representing the game medium for reward determined by the information change amount determination unit 2161 and the information 1206 representing the stamina consumption amount β determined by the information change amount determination unit 2161. As shown in FIG. 12, the information G1202 representing the game medium for reward may be in the form of displaying the game medium for reward.

Further, the output generation unit 217 may further output information representing the current automatic lap time (and/or the current number-of-laps, and so forth) being clocked by the lap time clocking unit 2142 based on a particular user's input (an example of a third predetermined user's input) until the first predetermined time elapses. The information representing the current automatic lap time is optionally set, for example, it may be in the form of a numerical value representing the current automatic lap time and/or the current number-of-laps (see information 930 of the interruption confirmation screen G1100 as described above), alternatively, in the form of a numerical value representing the remaining time (the remaining time until the first predetermined time elapses) and/or the remaining number-of-laps. In this case, the particular user's input is optionally set, for example, it may be an operation input for selecting the battle game part GP-m, or an operation input for calling the above-mentioned interruption confirmation screen G1100. Alternatively, the output generation unit 217 may automatically output the information representing the current automatic lap time when the user displays the home screen of the present game application. In this case, the information representing the current automatic lap time may be displayed small, for example, in a corner of the home screen or on the automatic lap button B900. In this case, the particular user's input (an example of the third predetermined user's input) corresponds to the input for the user to display the screen of the present game application.

Further, the output generation unit 217 may further output information representing the game medium for reward according to the current automatic lap time (see information 910 of the interruption confirmation screen G1100 as described above) being clocked by the lap time clocking unit 2142 based on a particular user's input (an example of a third predetermined user's input) until the first predetermined time elapses. In this case, the game medium for reward according to the current automatic lap time may be determined by the information change amount determination unit 2161. That is, the information change amount determination unit 2161 may determines the game medium for reward (game medium for reward according to the current automatic lap time) as the output by the output generation unit 217 when the first predetermined time is shortened. In this case, the specific user's input is optionally set, for example, it may be an operation input for selecting the battle game part GP-m, or an operation input for calling the above-mentioned interruption confirmation screen G1100. Alternatively, the output generation unit 217 may automatically output the information representing the game medium for reward according to the current automatic lap time when the user displays the home screen of the present game application. In this case, the information representing the game medium for reward according to the current automatic lap time may be displayed, for example, in a corner of the home screen. In this case, the particular user's input (an example of the third predetermined user's input) corresponds to the input for the user to display the screen of the present game application.

Note that the output generation unit 217 may further output information representing the amount of stamina consumed according to the current automatic lap time in the same manner, such as the information 920 of the interruption confirmation screen G1100 as described above, based on a particular user's input (an example of a third predetermined user's input) until the first predetermined time elapses. The information representing the amount of stamina consumed according to the current automatic lap time may be displayed together with the information representing the current automatic lap time and/or the information representing the game medium for reward according to the current automatic lap time.

The start data generation unit 218 generates start data for starting the manual-play battle game part (here, as an example, the battle game part GP-k+1). For example, the start data generation unit 218 sets various parameters required for executing the battle game part GP-k+1 based on the user data in the user data storage unit 210. For example, the start data generation unit 218 extracts information about the first game medium belonging to each deck selected by the user as deck information, and calculates the total HP of (total HP for each deck) at the start of the automatic lap of the battle game part GP-k+1 based on the deck information. At this time, the start data generation unit 218 calculates the total HP by a predetermined calculation method. The predetermined calculation method is optionally set, but in this case, it is a method of summing up the HP of the first game media constituting the deck for each deck. The predetermined calculation method is not limited to this. For example, the predetermined calculation method may be a calculation method in which a predetermined coefficient is multiplied by a value obtained by summing up the HP of the first game media constituting the deck. In this case, the predetermined coefficient may be set based on the information about the game function associated with the particular first game medium belonging to the deck. Hereinafter, the total HP calculated by a predetermined calculation method based on the deck information in this way is also referred to as a “normal value of the total HP.”

The second game advancing unit 219 advances the battle game part GP-k+1 based on the operation information acquired by the operational information acquisition unit 212 and the start data generated by the start data generation unit 218, when the manual-play battle game part (e.g., the battle game part GP-k+1) has started. The advancing method of the battle game part GP-k+1 is substantially the same as the advancing method of the battle game part (independent battle game part) as described above.

The second game advancing unit 219 includes an update processing unit 2191, a determination processing unit 2192, a post-termination processing unit 2193, and an effect production processing unit 2194.

The update processing unit 2191 updates the total HP (total HP of the decks currently used in the battle) from the initial value (value of the start data) as advancing the battle game part GP-k+1 from the start. For example, the update processing unit 2191 decreases the total HP by the amount of the damage when the first game medium is damaged by the attack of the opponent during the execution of the battle game part GP-k+1. Further, the update processing unit 2191 increases the total HP when, for example, a recovery item is acquired during the execution of the battle game part GP-k+1.

The determination processing unit 2192 determines whether or not the predetermined termination condition of the battle game part GP-k+1 is met. As described above, the determination processing unit 2192 determines that the predetermined termination condition is met when the battle game part GP-k+1 is cleared. Further, the determination processing unit 2192 determines that the predetermined termination condition is met when the total HP updated by the update processing unit 2191 and the total HP of the last deck becomes 0 (zero). Further, not only the HP becomes 0 (zero), but also the elapse of the time limit may be set as a predetermined termination condition.

The post-termination processing unit 2193 executes various post-processing in cooperation with the server device 10, when the determination processing unit 2192 determines that the predetermined termination condition is met. For example, the post-termination processing unit 2193 executes processing of generating and outputting a result screen showing a result or a reward, processing of associating a reward or the like with a user, and the like.

The effect production processing unit 2194 continuously generates a game effect corresponding to the game function when a predetermined effect production condition is met. The predetermined effect production condition is optionally set, and may include a condition related to user's input. In the present disclosure, as an example, the predetermined effect production condition is met when a predetermined user's input to the first game medium meeting the predetermined activation condition is detected. In addition, the activation condition may be the elapse of a predetermined time, the number of attacks against the opponent, and the like.

In this case, the effect production processing unit 2194 determines the predetermined activation condition for each first game medium. Then, as described above, the effect production processing unit 2194 continuously generates the game effects corresponding to the game function set in the first game medium, when a predetermined user's input to the first game medium meeting the predetermined activation condition is detected.

According to the configuration shown in FIG. 7, the above-mentioned automatic lap function can be appropriately realized with a reduced processing load. Specifically, the first game advancing unit 216 only performs simpler processing as compared with the processing by the second game advancing unit 219 (for example, while eliminating the need for game advancing processing such as each processing of the update processing unit 2191, the determination processing unit 2192, the post-termination processing unit 2193, and the effect production processing unit 2194), it is possible to output the termination result of the automatic lap of the battle game part GP-m. More specifically, since the automatic lap of the battle game part GP-m can be realized only by each processing of the information change amount determination unit 2161 and the user information update unit 2162, the processing load can be significantly reduced as compared with the case where the second game advancing unit 219 executes the processing related to the advancing repeatedly N times of the manual-play battle game part GP-m.

Further, according to the configuration shown in FIG. 7, the advancing management unit 215 can accept the first predetermined user's input in such a manner that does not affect the length of the first predetermined time, so that the user can easily start the automatic lap of the battle game part GP-m. As a result, the acquisition of the game medium for reward by the automatic lap of the battle game part GP-m is promoted, and the activity of the advancing game part 60 can be efficiently increased. In addition, the user can also play the out-game part playable in the present game application from the start of the automatic lap of the battle game part GP-m until the first predetermined time elapses, and the frequency in use of the present game application can also be increased efficiently.

Further, according to the configuration shown in FIG. 7, since the automatic lap function is realized without exchanging data for realizing the automatic lap function between the terminal device 20 and the server device 10, it is possible to reduce the risk that the automatic lap function is not realized due to communication environment (for example, a situation in which the automatic lap function is hindered due to the inability to exchange data due to a communication failure).

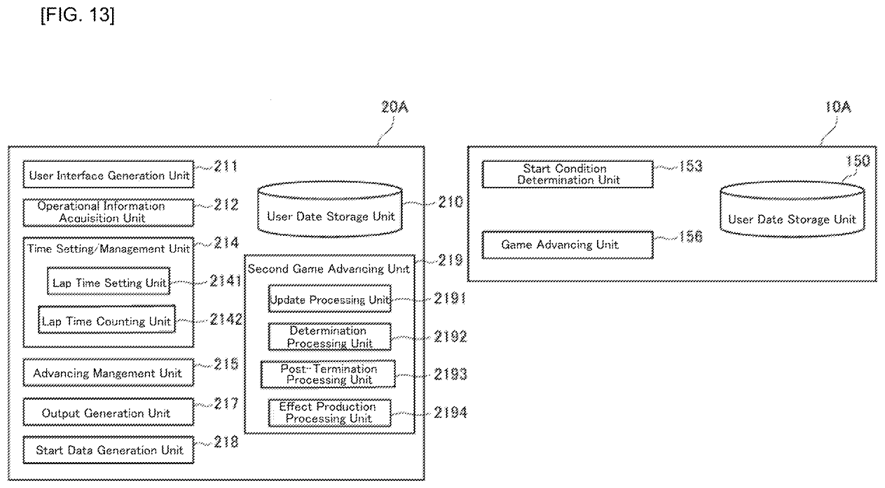

In the configuration shown in FIG. 7, the above-mentioned automatic lap function is mainly realized on the terminal device 20 side (that is, by the native application), but is not limited to this. For example, a part of the configuration shown in FIG. 7 may be realized (shared) by the server device 10. For example, in the embodiment shown in FIG. 13, a part of the configuration shown in FIG. 7 may be realized (shared) by the server device 10. In an example shown in FIG. 13, the functions of the start condition determination unit 213 and the first game advancing unit 216 are realized by the server device 10A. Specifically, the server device 10A includes a user data storage unit 150, a start condition determination unit 153, and a game advancing unit 156. Information about each user is stored in the user data storage unit 150. The information stored in the user data storage unit 210 of the terminal device 20A related to one user may be the data related to the one user among the user data stored in the user data storage unit 150. The start condition determination unit 153 functions for each user. The function of the start condition determination unit 153 realized for one user may be the same as the function of the start condition determination unit 213 as described above. The game advancing unit 156 functions for each user. The function of the game advancing unit 156 realized for one user may be the same as the function of the first game advancing unit 216 as described above. In an example shown in FIG. 13, the function of the second game advancing unit 219 is still realized by the terminal device 20A, but a part or all of the functions of the second game advancing unit 219 may be realized by the server device 10A.

### (Example of Game System Operation)

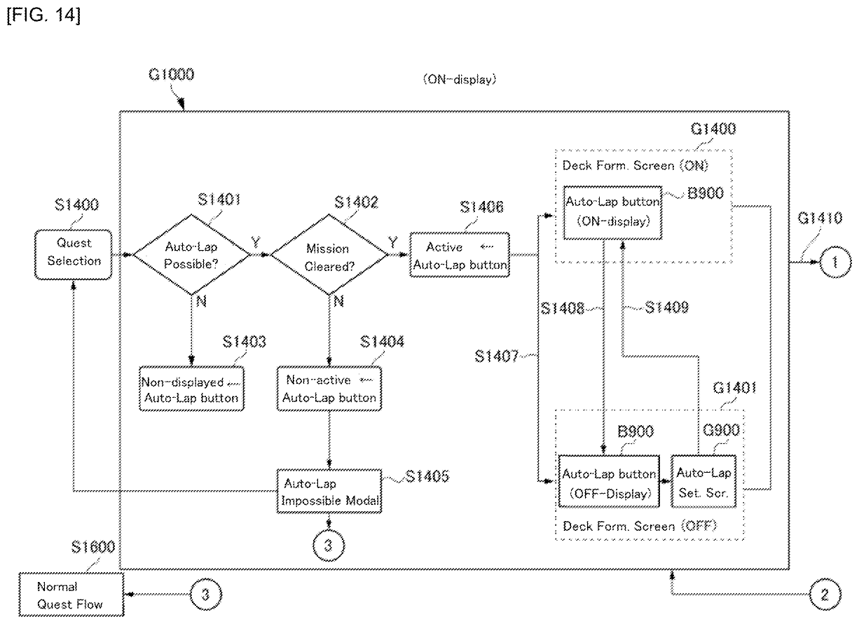

Next, with reference to FIG. 14 and the following figures, an operational example of the game system 1 is described. The following operational example is just an operational example and can be modified in various modes. Further, the following operational example is only related to a part of the above-mentioned functions with reference to FIG. 7 to FIG. 13 as an operational example.

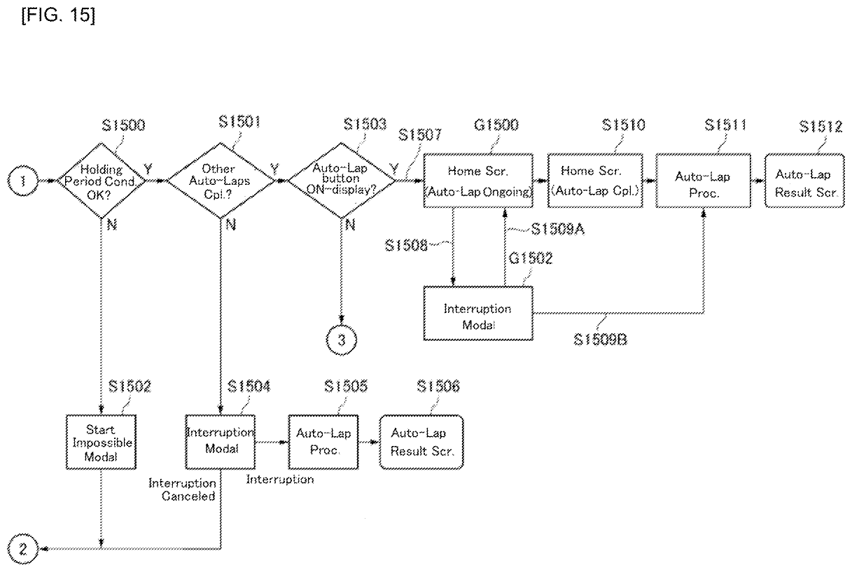

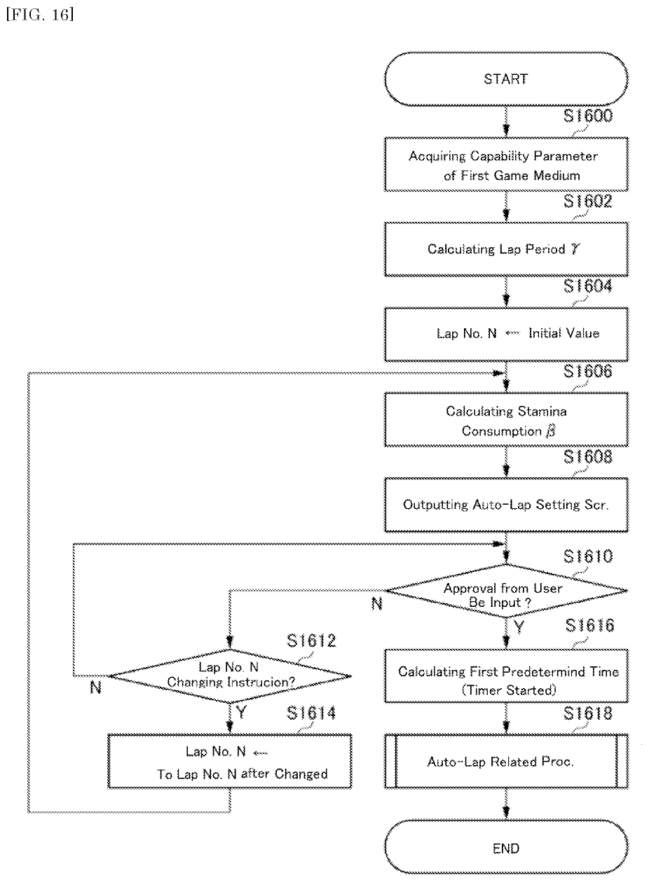

FIG. 14 and FIG. 15 are flowcharts showing an operational example of the game system 1 related to the automatic lap function. Hereinafter, one user (and one terminal device 20 used by the one user) are described, but the same is appliable to other users as well.

First, the user selects a desired battle game part GP (referred to as “quest” in FIG. 14) among a plurality of battle game parts GP-1 to GP-M forming the advancing game part 60 (Step S1400). Here, it is assumed that the battle game part GP-m is selected.

When the battle game part GP-m is selected, the deck formation screen G1000 (see FIG. 10) is output on the terminal device 20, and the terminal device 20 determines whether or not the battle game part GP-m as selected is capable of executing the automatic lap. It may be set in advance that which of the plurality of battle game parts GP-1 to GP-M is capable to executing the automatic lap. If the battle game part CP-m as selected is capable of executing the automatic lap (“YES” in Step S1401), the processing proceeds to Step S1402, otherwise (“NO” in Step S1401), the automatic lap button B900 (see FIG. 10) is hidden (Step S1403).

In Step S1402, the terminal device 20 determines whether or not the conditional element K2 as described above among the predetermined start conditions related to the automatic lap is met. As mentioned above, the conditional element K2 is met in a case where the manual-play battle game part GP-m is cleared and the predetermined mission associated with the manual-play battle game part GP-m is cleared. Note that, in Step S1402, other condition elements (e.g., the condition element K2-3) as described above may also be determined. When the condition element K2 is met (“YES” in Step S1402), the processing proceeds to step 51406, otherwise (“NO” in Step S1402), the terminal device 20 makes non-active the automatic lap button B900 (see FIG. 10) (Step S1404). In this case, when the user operates the automatic lap button B900 by, for example, tapping it, the terminal device 20 outputs a modal window (not shown) (an “automatic lap impossible modal” represented in FIG. 14) indicating that the automatic lap is impossible.) is output (step S1405). In this case, the modal window includes a user interface, and the user can select another battle game part or proceed to a normal battle game part (referred to as “normal quest flow” in FIG. 14) (Step S1600). The second game advancing unit 219 mainly executes the normal battle game part processing as described above, although not shown.

In Step S1406, the terminal device 20 activates the automatic lap button B900 (see FIG. 10) and turns on or off the deck formation screen G1000 (see FIG. 10) (Step S1407). Whether to turn on or turn off the deck formation screen G1000 (see FIG. 10) may be determined according to the setting at the start of the previous battle game part GP.

In a state that the deck formation screen G1000 (see FIG. 10) is turned on (see G1400), the automatic lap button B900 (see FIG. 10) is turned to ON-display. The ON-display may be realized, for example, by increasing display brightness of the automatic lap button B900 (see FIG. 10). If the user desires the automatic lap of the battle game part GP-m, the user turns the automatic lap button B900 (see FIG. 10) to ON-display and then operates the start button B902 (see FIG. 10). That is, the user who desires the automatic lap of the battle game part GP-m operates the start button B902 (see FIG. 10) in a state that the deck formation screen G1000 (see FIG. 10) is turned on (see G1400) (Step S1410). When the automatic lap button 11900 (see FIG. 10) is operated by the user, for example, by tapping it, the deck formation screen G1000 (see FIG. 10) is turned off (Step S1408).

In a state that the deck formation screen G1000 (see FIG. 10) is turned off (see G1401), the automatic lap button B900 (see FIG. 10) is turned to OFF-display. In this case, when the automatic lap button B900 (see FIG. 10) is operated by the user, for example, by tapping it, transition to the automatic lap setting screen G900 (FIG. 9) is realized.

That is, the automatic lap setting screen G900 (see FIG. 9) is output in the form of a modal window. When the user operates the OK-button B905 on the automatic lap setting screen 6900 (see FIG. 9) by, for example, tapping it, the automatic lap button B900 (see FIG. 10) is turned to ON-display and the deck formation screen G1000 (see FIG. 10) is turned on (Step S1409). If the user does not desire the automatic lap of the battle game part GP-m, the user turns the automatic lap button B900 (see FIG. 10) to OFF-display and then operates the start button B902 (see FIG. 10). That is, the user who does not desire the automatic lap of the battle game part GP-m operates the start button B902 (see FIG. 10) in a state that the deck formation screen G1000 (see FIG. 10) is turned off (see G1401) (Step S1410).

When the start button B902 (see FIG. 10) is operated (Step S1410), the processing proceeds to Step S1500 in FIG. 15. In Step S1500, the terminal device 20 determines whether or not the condition element (see the condition element K3 as described above) related to the holding period of the automatic lap of the current battle game part GP-m is met. For example, in a situation where the deadline for the automatic lap of the current battle game part GP-m is 23:59:59 on Dec. 31st, if the first predetermined time is set to be 10 minutes or longer, and the current time is 23:50 or later, it may be determined that the condition element related to the holding period is not met. If the condition clement related to the holding period is met (“YES” in Step S1500), the processing proceeds to Step S1501, otherwise (“NO” in Step S1500), a modal window (not shown) (an “start impossible modal” represented in FIG. 14) indicating that the start is impossible is output (Step S1502), and the screen returns to a displaying state of the deck formation screen G1000 shown in FIG. 14.

Tn Step S1501, the terminal device 20 determines whether or not the automatic lap of the other battle game part GP has been completed. For example, if the user has started the automatic lap of other battle game part GP immediately before, it is determined that the automatic lap of the other battle game part GP has not been completed. That is, for example, when the automatic lap of one battle game part GP has started, the automatic lap of the one battle game part GP is not counted as completed until the first predetermined time related to the automatic lap of the one battle game part GP elapses. Note that, if the automatic lap of the current battle game part GP-m is the first automatic lap for the user, it is determined that the automatic lap of other battle game part GP has been completed. If the automatic lap of other battle game part GP has been completed (“YES” in Step S1501), the processing proceeds to Step S1503, otherwise (“NO” in Step S1501), the processing proceeds to Step S1504.

In Step S1503, the terminal device 20 determines whether or not the automatic lap button B900 (see FIG. 10) was turned to ON-display when the start button B902 was operated. If the automatic lap button B900 (see FIG. 10) is turned to ON-display when the start button B902 was operated (“YES” in Step S1503), a home screen (not shown) including the automatic lap button B900 (see FIG. 10) is output (Step S1507). On the other hand, if the automatic lap button B900 (see FIG. 10) was turned to OFF-display when the start button B902 was operated (“NO” in Step S1503), the processing proceeds to the normal battle game part processing (not shown) (Step S1600).

In Step S1504, the terminal device 20 outputs a modal window (see the interruption confirmation screen G1100 in FIG. 11) (denoted as a “interruption modal” in FIG. 14) allowing the user to select whether or not the user interrupts the automatic lap of the other battle game part GP (the automatic lap of the other battle game part GP for which the first predetermined time has not yet elapsed at present time), and the user's selection is awaited. If the user selects not to interrupt the automatic lap of the other battle game part GP (“interruption cancel” in Step S1504), the displaying state returns to the deck formation screen G1000 shown in FIG. 14. On the other hand, if the user makes an input (i.e., first operation input) to interrupt the automatic lap of other battle game part GP (“interrupt” in Step S1504), the terminal device 20 executes the automatic lap processing (Step S1505) for such as determining the game medium for reward based on the shortened first predetermined time, and outputs a screen (see an output screen G1200 of termination result in FIG. 12) (denoted as “automatic lap result screen” in FIG. 14) showing the result (Step S1506).

The home screen (not shown) including the automatic lap button B900 (see FIG. 10) is maintained until the first predetermined time elapses. However, as described above, the user can also move the home screen to the background and play an out-game part from the home screen.

When the automatic lap button B900 (see FIG. 10) is operated by the user on the home screen (not shown) until the first predetermined time elapses (that is, when a particular user's input is performed) (Step S1508), the terminal device 20 outputs a modal window G1502 (see the interruption confirmation screen G1100 in FIG. 11) allowing the user to select whether or not the user interrupts the current automatic lap (the automatic lap of the battle game part GP-m for which the first predetermined time has not yet elapsed at present time) of the battle game part GP-m, and the user's selection is awaited. If the user does not desire to interrupt the automatic lap of the current battle game part GP-m, the user presses a NO-button (see NO-button B1102 in FIG. 11) to be able to remove the modal window G1502 and return to the home screen (not shown) (Step S1509A). On the other hand, if the user desires to interrupt the automatic lap of the current battle game part GP-m, the user presses a YES-button (see YES-button B1104 in FIG. 11) to be able to proceed to Step S1511 (Step S1509B). In this case, the terminal device 20 executes the automatic lap processing (Step S1511) for such as determining the game medium for reward based on the shortened first predetermined time, and outputs a screen (see an output screen G1200 of termination result in FIG. 12) showing the result (Step S1512).

Further, when the first predetermined time related to the automatic lap of the current battle game part GP-m has elapsed, a home screen (not shown) inclusive of information representing that the automatic lap has normally terminated is output (Step S1510). Note that, when the user who has moved a home screen to the background returns the screen of this game application to a foreground (a state where commands are inputtable) after the first predetermined time has elapsed, a home screen (not shown) inclusive of information representing that the automatic lap has normally terminated may be output. Further, when the user who has been playing the out-game part of the present game application returns to a home screen of the present game application after the first predetermined time has elapsed, a home screen (not shown) inclusive of information representing that the automatic lap has normally terminated may be output. Further, when the user who has stopped the present game application due to so-called “task kill” starts the present game application after the first predetermined time has elapsed, a home screen (not shown) inclusive of information representing that the automatic lap has normally terminated may be output. Further, when the user who has turned off the power of the terminal device 20 turns on the power of the terminal device 20 after the first predetermined time has elapsed and starts up the present game application, a home screen (not shown) inclusive of information representing that the automatic lap has normally terminated may be output.

When the automatic lap button B900 (see FIG. 10) is operated on the home screen (not shown) inclusive of information representing that the automatic loop has normally terminated, the terminal device 20 executes the automatic lap processing (Step S1511) for such as determining the game medium for reward based on the first predetermined time, and outputs a screen (see an output screen G1200 of termination result in FIG. 12) showing the result (Step S1512). Note that, as described above, a part or all of the automatic lap processing may be executed before the first predetermined time elapses. For example, the game medium for reward in this case may be determined in advance based on the first predetermined time set on the automatic lap setting screen G900 (see FIG. 9). That is, the game medium for reward in this case may be calculated at any timing from when the start button B902 is operated until when the first predetermined time elapses, or may be calculated before the start button B902 is operated.

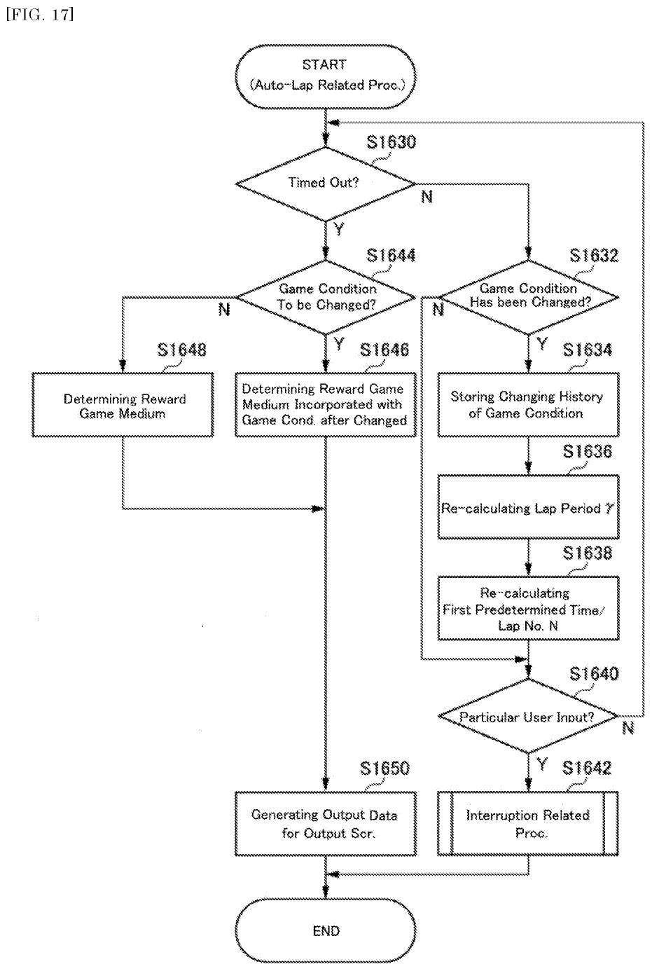

Next, with reference to FIG. 16 to FIG. 18, an example of a method of calculating various values required for generating the automatic lap setting screen G900 of FIG. 9 and the interruption confirmation screen G1100 of FIG. 11 is described using flowcharts.

FIG. 16 is a schematic flowchart showing an example of a method of calculating various values required for generating the automatic lap setting screen G900 (see FIG. 9) and subsequent processing related thereto. The processing shown in FIG. 16 may be executed when a user's input to call up the automatic lap setting screen G900 (see FIG. 9) occurs.

In Step S1600, the terminal device 20 acquires the value of the capability parameter for each first game medium.

In Step S1602, the terminal device 20 calculates the lap period γ based on the value of the capability parameter obtained in Step S1600. In this case, the terminal device 20 may calculate the lap period γ in such a manner that the higher the value of the capability parameter, the shorter the lap period γ becomes. For example, the lap period γ may be expressed by the following formula, where η is the value of the capability parameter.

γ=Tref×1/η

The value of the capability parameter may be only a value of a particular capability parameter (e.g., a value of a capability parameter related to offensive power), or may be an average value of values of a plurality of capability parameter. Also, the terminal device 20 may calculate a shorter lap period γ when the predetermined second shortening condition as described above is met.

In Step S1604, the terminal device 20 sets the number-of-laps N to a default number of times as an initial value. The default number of times may be the previous value for the same user.

In Step S1606, the terminal device 20 calculates the stamina consumption amount β consumed in the current automatic lap based on the number-of-laps N set in Step S1604. The stamina consumption amount β may be calculated based on the stamina consumption amount per lap in such a manner that the greater the number-of-laps N, the greater the stamina consumption amount β becomes, as described above.

In Step S1608, the terminal device 20 outputs/updates the automatic lap setting screen G900 (see FIG. 9) inclusive of the number-of-laps N set in Step S1604 and the stamina consumption amount β calculated in Step S1606.

In Step S1610, the terminal device 20 determines whether or not an approval input has been obtained from the user. The approval input may be generated, for example, by operating the OK-button on the automatic lap setting screen G900 of FIG. 9. When an approval input from the user has been obtained (“YES” in Step S1610), the processing proceeds to Step S1618 (“NO” in Step S1610), otherwise, the processing proceeds to Step S1612.

In Step S1612, the terminal device 20 determines whether or not an input instructing to change the number-of-laps N has been obtained from the user. When the determination result is “YES”, the processing proceeds to Step S1614, otherwise, the processing returns to Step S1610 to await an approval input from the user.

In Step S1614, the terminal device 20 sets the number-of-laps N to the number after changed. When Step S1614 ends, the stamina consumption amount β is calculates again based on the changed number-of-laps N from Step S1606 to update the display 902 (indicating the stamina consumption amount β to be planned to be consumed) of the automatic lap setting screen G900 of FIG. 9.

In Step S1616, the terminal device 20 calculates the first predetermined time based on the number-of-laps N set in Step S1604 or Step S1614 and the lap period γ calculated in Step S1602, and start a timer that times out according to the first predetermined time as calculated.

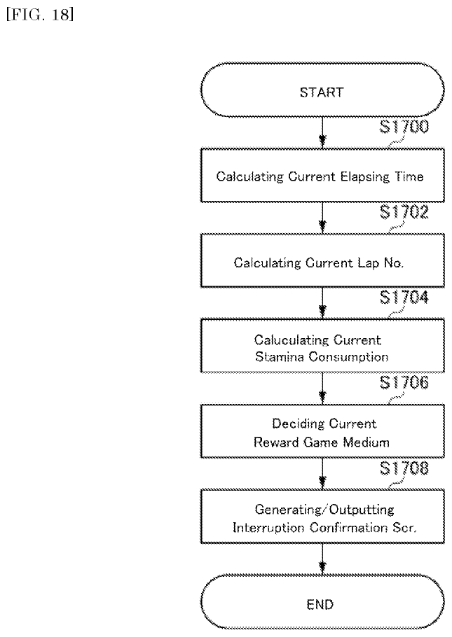

In Step S1618, the terminal device 20 executes an automatic lap-related processing. An example of the automatic lap-related processing is described below with reference to FIG. 17.

FIG. 17 is a schematic flowchart showing an example of the automatic lap-related processing (Step S1618) shown in FIG. 16.

In Step S1630, the terminal device 20 determines whether or not the timer set in Step S1616 has timed out. If the determination result is “YES”, the processing proceeds to Step S1644, otherwise, the processing proceeds to Step S1632.

In Step S1632, the terminal device 20 determines whether or not a predetermined game condition has been changed. The predetermined game condition is as described above, but here, the predetermined game conditions include the growth parameter value of the in-use game media and the acquisition number of particular items. It may be determined that a predetermined game condition has been changed when the growth parameter value was changed during the automatic lap of the battle game part GP-m, or when particular items were acquired (obtained) more than a predetermined number. The predetermined number may be any number equal to or greater than one. Alternatively, it may he determined that the predetermined game condition has been changed when an element of the first game medium was changed in other game part such as the out-game part. The change of the predetermined game conditions during the automatic lap of the battle game part GP-m may be realized depending on input from the user (e.g , input with temporary interruption or input of reservation in advance), or may be realized automatically. For example, the user can temporarily interrupt the automatic lap of the battle game part GP-m to increase the growth parameter value in the out-game part during the automatic lap of the battle game part GP-m, and use the growth parameter value as increased (that is, change the predetermined game condition). Note that such interruption may be realized in an interruption-related process in Step S1642 as described later. When the determination result is “YES”, the processing proceeds to Step S1634, otherwise, the processing proceeds to Step S1640.

In Step S1634, the terminal device 20 stores the change history of the predetermined game condition. The change history of the predetermined game conditions may include information such as the number-of-laps at the time of change.

In Step S1636, the terminal device 20 re-calculates the lap period γ based on the changed predetermined game condition. The lap period γ may be calculated in the same manner as in Step S1602. In this case, the lap period γ may be calculated in such a manner that the greater the growth parameter value, the shorter the lap period γ becomes. Also, the lap period γ may be calculated in such a manner that the growth parameter value becomes shorter when particular items more than a predetermined number are acquired as compared with when it is not so.

In Step S1638, the terminal device 20 re-calculates (changes) the first predetermined time based on the lap period γ re-calculated in Step S1636, and changes the timing that the timer times out to time out according to the first predetermined time as re-calculated. Alternatively, the terminal device 20 may re-calculate the number-of-laps N based on the lap period γ as re-calculated in Step S1636 without changing the timer.

In this case, when the re-calculated value of the lap period γ becomes shorter than the original calculated value thereof, the recalculated value of the number-of-laps N becomes greater than the original calculated value thereof. Further, when particular items more than a predetermined number are acquired, the terminal device 20 may shorten the first predetermined time from the original value, or may increase the number-of-laps N from the original value. Note that, when the predetermined game condition was changed, the user may be allowed to select whether to change the first predetermined time or to change the number-of-laps N in advance (for example, on a screen such as the automatic lap setting screen G900). When the number-of-laps N is changed, the stamina consumption amount β may be changed accordingly, or the stamina consumption amount β may be maintained.

In Step S1640, the terminal device 20 determines whether or not a particular user's input has occurred from the user. For example, the terminal device 20 determines whether or not a user's input to call up the interruption confirmation screen G1100 (see FIG. 11) has occurred. When the determination result is “YES”, the processing proceeds to Step S1642, otherwise, the processing is repeated from Step S1630.

In Step S1642, the terminal device 20 executes the interruption-related processing for generating the interruption confirmation screen G1100 of FIG. 11. An example of the interruption-related processing is described below with reference to FTG. 17.

In Step S1644, the terminal device 20 determines, whether or not the predetermined game condition has been changed in the automatic lap of the current battle game part GP-m having terminated based on the change history of the predetermined game condition. When the determination result is “YES”, the processing proceeds to Step S1646, otherwise, the processing proceeds to Step S1648.

In Step S1646, the terminal device 20 determines the game medium for reward to be given to the user in the current automatic lap based on the predetermined game condition as changed. For example, when the number-of-laps N has been changed due to a change in the predetermined game condition, the terminal device 20 determines the game medium for reward to be given to the user in the current automatic lap based on the number-of-laps N after changed. As described above, the game medium for reward may be determined in such a manner that the greater the number-of-laps N, the higher its usefulness becomes.

In Step S1648, the terminal device 20 determines the game medium for reward to be given to the user in the current automatic lap based on the number-of-laps N set in Step S1604 or Step S1614 as described above. the game medium for reward may be, as described above, determined in such a manner that the greater the number-of-laps N, the higher its usefulness becomes. Note that the processing of Step S1648 may be executed immediately after the timer set in Step S1616 has started or in advance before the timer set in Step S1616 times out.

In Step S1650, the terminal device 20 generates output data for the output screen G1200 outputting the termination result inclusive of information about the game medium for reward determined in Step S1618 (see information G1202 representing the game medium for reward in FIG. 12). The termination result based on the output data generated in this way is outputtable on the output screen G1200, and may be output immediately depending on an output instruction from the user.

Note that, although not shown in FIG. 17, the timer set in Step S1616 may be allowed to accelerate the time-out timing based on the second predetermined user's input for shortening or extending the first predetermined time as described above.

Such processing shown in FIG. 17 is suitable for games configured with specifications in which the predetermined game condition is changed during the automatic lap. In a case of a game configured with specifications in which the predetermined game condition is not changed during the automatic lap, or in which the capability parameter is maintained during the automatic lap of the battle game part GP-m even when the predetermined game condition is changed, Step S1632 to Step S1638, Step S1644 and Step S1646 may be omitted.

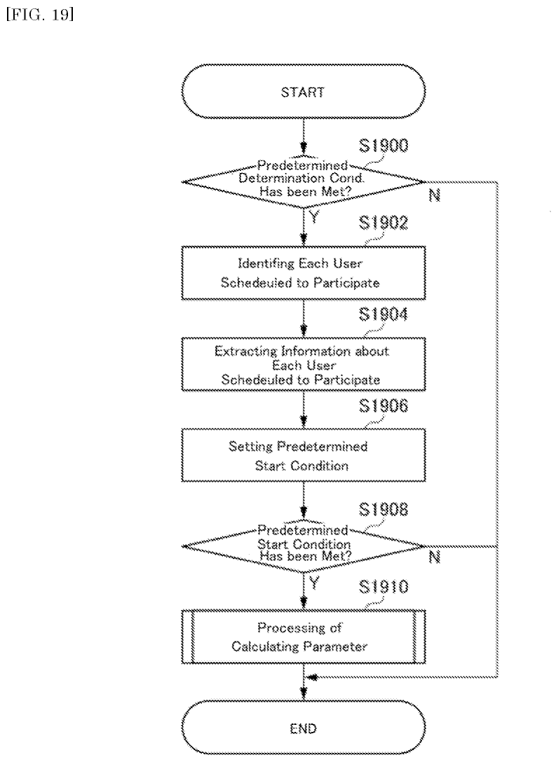

FIG. 18 is a schematic flow chart showing an example of a method of calculating various values required for generating the interruption confirmation screen G1100 of FIG. 11.

The flow shown in FIG. 18 may be executed as the interruption-related processing (Step S1642) shown in FIG. 17.

In Step S1700, the terminal device 20 calculates the current automatic lap time based on the timer activated in Step S1616 of FIG. 16. Note that the terminal device 20 may calculate the current automatic lap time based on the time information at the time when the timer was activated in Step S1616 of FIG. 16.

In Step S1702, the terminal device 20 calculates the current number-of-laps based on the current automatic lap time calculated in Step S1700 and the lap period γ calculated in Step S1602 of FIG. 16. For example, the current number-of-laps may be calculated as follows: current number-of-laps =current automatic lap time/lap period γ . In this case, a remainder may be rounded down or up.

In Step S1704, the terminal device 20 calculates the current consumption amount of stamina (a part of the stamina consumption amount β) based on the current number-of-laps calculated in Step S1702.

In Step S1706, the terminal device 20 determines the current game medium for reward based on the current number-of-laps calculated in Step S1702. In this case, as well as in Step S1618 of FTG. 16, the game medium for reward may be determined in such a manner that the greater the number-of-laps N, the higher its usefulness becomes, as described above.

In Step S1708, the terminal device 20 generates and outputs the interruption confirmation screen G1100 inclusive of the current number-of-laps calculated in Step S1702, the current stamina consumption amount calculated in Step S1704, and the current game medium for reward determined in Step S1706.

Next, the operation of the server device 10 and the terminal device 20 that execute the multi-play battle game part for is outlined based on the description of the operation of the server device 10 and the terminal device 20 that execute the single-play battle game part.

FIG. 19 is a schematic flow chart for explaining the success/failure determination processing for determining the predetermined start condition related to the automatic lap of the multi-play battle game part.

In Step S1900, the terminal device 20 determines whether or not a predetermined determination condition for determining success/failure of the predetermined start condition related to the automatic lap of the multi-play battle game part has been met. The predetermined determination condition may be met in a case where the user calls up the automatic lap setting screen (not shown) related to the automatic lap of the multi-play battle game part, which is exemplified by the automatic lap setting screen G900 (see FIG. 9). When the determination result is “YES”, the processing proceeds to Step S1902, otherwise, the processing terminates.

Note that, in a case of the multi-play battle game part, it may be possible to generate the automatic lap setting screen after a plurality of users (players) have gathered. In this case, the predetermined determination condition may be met when two or more users have gathered. Further, in a case of the multi-play battle game part, it may be possible to generate the automatic lap setting screen by only one user (e.g., a host user) among a plurality of users under playing. Further, in a case of the multi-play battle game part, it may be possible to allow other users to participate (subsequent participation) in the automatic lap of the multi-play battle game part set by the host user.

In Step S1902, the terminal device 20 identifies each user scheduled to participate.

In Step S1904, the terminal device 20 extracts information about each user scheduled to participate and/or information about the in-use game medium of each user scheduled to participate (see FIG. 2 and FIG. 3). Note that the information about the in-use game media by each user scheduled to participate may be obtained from the server device 10.

In Step S1906, the terminal device 20 sets the predetermined start condition (an example of information required for realizing the automatic lap of the multi-play battle game part) related to the automatic lap of the multi-play battle game part based on the information obtained in Step S1904. For example, the predetermined start condition related to the automatic lap of the multi-play battle game part may be set based on information about a representative user (e.g., a host user) among users scheduled to participate and/or information about the in-use game medium (see FIG. 2 and FIG. 3). In this case, for example, the predetermined start condition may be set looser for a host user with relatively higher rank than a host user with relatively lower rank. Further, the predetermined start condition may be set looser when the value of the capability parameter of the in-use game media of a host user is relatively higher than when it is relatively lower.

In Step S1908, the terminal device 20 determines whether or not the predetermined start condition set in Step S1906 is met. The predetermined start condition related to the automatic lap of the multi-play battle game part may be determined for each user scheduled to participate. In this case, the predetermined start condition applied to each user scheduled to participate may be the same as the predetermined start condition related to the single-play battle game part as described above. Alternatively, the predetermined start condition related to the automatic lap of the multi-play battle game part may be set taking into consideration average, maximum value, minimum value, etc. of each parameter of a plurality of users scheduled to participate. Alternatively, the predetermined start condition related to the automatic lap of the multi-play battle game part may be applied only to a part of users (e.g., a host user) scheduled to participate. When the determination result is “YES”, the processing proceeds to Step S1910, otherwise, the processing terminates.

Tn Step S1910, the terminal device 20 executes parameter calculation processing for calculating parameter for multi-play and automatic lap. An example of the parameter calculation processing is described below with reference to FIG. 20.

FIG. 20 is a schematic flow chart showing an example of a method of calculating and subsequent processing associated therewith, the method calculating various values (another example of information required for realizing the automatic lap of the multi-play battle game part) required for generating the automatic lap setting screen (not shown) such as the automatic lap setting screen G900 (see FIG. 9). The flow shown in FIG. 20 may be executed as the parameter calculation processing for multi-play and automatic lap (Step S1342) shown in FIG. 19.

In Step S2000, the terminal device 20 extracts information about each participating user (an example of a first player and a second player) and/or information about the in-used game medium of each participating user (examples of a first player character and a second player character) (see FIG. 2 and FIG. 3).

In Step S2002, the terminal device 20 calculates the lap period γ based on each information obtained in step S2000. In this case, for example, the terminal device 20 may calculate the lap period γ in such a manner that the higher the value of the capability parameter of the in-use game media of each participating user, the shorter the lap period γ becomes. Alternatively, the terminal device 20 may calculate the lap period γ in such a manner that the higher the rank value of each participating user, the shorter the lap period γ becomes. Further, the lap period γ may tend to be shorter for multi-play than for single-play as described above. In this case, under the same condition where the first predetermined time is the same, the multi-play mode is more advantageous, so the automatic lap of the multi-play battle game part (and interaction between users related thereto) is promoted.

In Step S2004, the terminal device 20 sets the number-of-laps N to a default number of times as an initial value. The default number for multi-play may be, for example, a minimum value (i.e., “1”).

Tn Step S2006, the terminal device 20 calculates the stamina consumption amount β consumed in the current automatic lap based on the number-of-laps N set in step S2004. The stamina consumption amount β may be calculated based on the stamina consumption amount per lap in such a manner that the greater the number-of-laps N, the greater the stamina consumption amount β becomes, as described above. Note that the number-of-laps N and the stamina consumption amount β may be common to each participating user, or may be calculated individually based on information about each participating user and/or information about the in-use game media of each participating user. Further, the stamina consumption amount β may tend to be smaller for multi-play than for single-play as described above. In this case, under the same condition where the number-of-laps N is the same, the multi-play mode is more advantageous, so the automatic lap of the multi-play battle game part (and interaction between users related thereto) is promoted.

In Step S2008, the terminal device 20 outputs/updates the automatic lap setting screen for multi-play (not shown) corresponding to the automatic lap setting screen G900 (see FIG. 9), which includes the number-of-laps N set in Step S2004 and the stamina consumption amount β calculated in Step S2006.

In Step S2010, the terminal device 20 determines whether or not an approval input has been obtained from each participating user. When an approval input has been obtained from each participating user (“YES” in Step S2010), the processing proceeds to Step S2018 (“NO” in Step S2010), otherwise, the processing proceeds to Step S2012.

In Step S2012, the terminal device 20 determines whether or not an input instructing to change the number-of-laps N has been obtained from anyone of the participating users (e.g the host user). The upper limit of the number-of-laps N may be set according to the minimum value of each stamina possessed by each participating user. When the determination result is “YES”, the processing proceeds to Step S2014, otherwise, the processing returns to Step S2010 to await an approval input from each participating user.

In Step S2014, the terminal device 20 sets the number-of-laps N to the number after changed. When Step S2014 ends, the stamina consumption amount β is calculated again based on the changed number-of-laps N from Step S2006 to update the automatic lap setting screen (not shown).

In Step S2016, the terminal device 20 calculates the first predetermined time based on the number-of-laps N set in Step S2004 or Step S2014 and the lap period γ calculated in Step S2002, and start a timer that times out.

In Step S2018, the terminal device 20 determines the game medium for reward to be given to each participating user in the current automatic lap based on the number-of-laps N set in Step S2004 or Step S2014. The reward game media may be common to each participating user, or may be calculated individually based on information about each participating user and/or information about the in-use game media of each participating user. In this case, the game medium for reward may be determined in such a manner that the greater the number-of-laps N, the higher its usefulness becomes. Also, the game medium for reward may be determined as a type of an event that occurs during the automatic lap or a privilege (a game medium for reward) that can be obtained during an automatic lap based on the number-of-laps N set in Step S2004 or Step S2014. Note that Step S2018 may be executed later than immediately after the timer set in Step S2016 has started, or may be executed when the timer set in Step S2016 has timed out.

In Step S2020, the terminal device 20 generates to generate output data for the output screen (not shown) of the termination result inclusive of information about the game medium for reward determined in Step S2018, which is the output screen for multi-play corresponding to the output screen G1200 (see FIG. 12) for single-play. Note that Step S2020 may be executed later than immediately after the timer set in Step S2016 has started, or may be executed when the timer set in Step S2016 has timed out. The output screen G1 200 of the termination result based on the output data thus generated is outputtable after the timer set in Step S2016 has timed out.

Note that, although not shown in FIG. 20, the timer set in Step S2016 may be allowed to accelerate the time-out timing based on the second predetermined user's input for shortening or extending the first predetermined time as described above. Also, although not shown in FIG. 20, as described above with reference to FIG. 17, the predetermined game condition may be changed during also the automatic lap of the multi-play battle game part, in this case, the termination timing (the first predetermined time) and the number-of-laps N (and accordingly, the stamina consumption amount β and the game medium for reward) may be changed based on the predetermined game condition after changed.

### (Modification)

As above, although the embodiments have been described in detail with reference to the drawings, the specific configurations are not limited to the various embodiments as described above and include the following modifications within the scope of the present disclosure.

For example, in the above-described embodiment, one battle game part GP-m is automatically playable N times in succession. As a modification, two or more battle game parts may be automatically playable N times in succession. In this case, the N times may differ for each battle game part.

Further, in the above-described embodiment, the user can automatically play one battle game part GP-m N times in succession, when the predetermined start condition for one battle game part GP-m is met, on condition that that the stamina corresponding to the stamina consumption amount β associated with the user is canceled (consumed). As a modification, in place of or in addition to this, the user can play manually or semi-automatically one battle game part GP-m N times in succession, when the predetermined start condition for one battle game part GP-m is met, on the condition that the stamina corresponding to a predetermined amount β′ is consumed. In this case, when the N times are the same, the predetermined amount β′ may be the same as the stamina consumption amount β, or may be smaller than the stamina consumption amount β. Note that advancing manually the one battle game part GP-m N times in succession may be realized by the second game advancing unit 219.

Further, in the above-described embodiment, the first game advancing unit 216 (the information change amount determination unit 2161 thereof) determines the termination result (the game medium for reward , etc.) of advancing (an example of a predetermined advancement) repeatedly N times of the battle game part GP-m based on the elapsed time (an example of the counting value of the first parameter: automatic lap time) updated by lap time clocking unit 2142 (an example of a count control unit) or the first predetermined time (an example of a setting value of the first parameter) determined by the lap time setting unit 2141 (an example of the parameter determination unit). As a modification, in place of or in addition to this, any or both of the following configurations may be adapted.

One configuration is that the termination result of a predetermined advancement is determined based on charging information of the player. For example, points consumed during the execution of the automatic lap function may be classified into types of pay points and free points, and then the player may be allowed to select either of them. When the player selects pay points, a type of the termination result such as an item acquirable after the battle game part GP-m has terminated may be changed. Also, in such a case, the same item with a higher parameter value or the same type of item with a higher rarity may be acquired, or the probability of acquiring these items may be increased. With such a configuration, a player who has charged can perform the automatic lap more efficiently than a player who has not.

Another configuration is that the player sets conditions for the termination result of the battle game part GP-m before starting the battle game part GP-m. For example, when executing the automatic lap function, before starting the automatic lap function, the player may select and set type, number, rarity, etc. of the termination result such as an item that the player desires to acquire after the battle game part G-P-m has terminated, and may determine a point condition such as an amount and/or a type of point required during the execution of the automatic lap function or combinations of different points based on the termination result as selected and set. Then, the battle game part GP-m may be executed at the timing when the point condition is met. With such a configuration, it is possible for the player to adjust the privileges and merits acquired in the automatic lap.

The following items are also disclosed based on the above-described embodiments.

[Item 1]

An information processing system comprising:
a condition determination unit of determining whether or not a predetermined start condition is met;
a first game advancing unit of automatically realizing a predetermined advancement of a game part with a first attribute associated with one user when it is determined that the predetermined start condition is met;
a clocking unit of starting to clock a predetermined time when the predetermined start condition is met;
an output generation unit of being capable of outputting a termination result of the predetermined advancement when the predetermined time has elapsed; and
an advancing management unit of being capable of accepting a first predetermined user's input until the predetermined time elapses.

[Item 2]

The information processing system according to Item 1,
wherein the advancing management unit is capable of accepting the first predetermined user's input while maintaining the predetermined advancement.

[Item 3]

The information processing system according to Items 1 or 2,
wherein the first predetermined user's input includes at least one of an input for starting and advancing a game part with a second attribute different from the first attribute, an input for making non-displayed a game screen displaying the game part with the first attribute, and an input for starting or executing an application different from an application related to the game part of the first attribute.

[Item 4]

The information processing system according to Item 3,
wherein the game part with the first attribute involves a battle using game media, and
wherein the game part with the second attribute does not involve a battle using game media, or has a lower frequency of battle with game media than the game part with the first attribute.

[Item 5]

The information processing system according to any one of Items 1 to 4,
wherein the advancing management unit restricts acceptance of a first operation input for starting another game part with a first attribute same as the first attribute until the predetermined time elapses.

[Item 6]

The information processing system according to Item 5,
wherein the advancing management unit accepts the first operation input on condition that the predetermined time period has elapsed.

[Item 7]

The information processing system according to any one of Items 1 to 6,
wherein the first game advancing unit comprising:
an information change amount determination unit of determining a game medium for reward according to a length of the predetermined time or the game medium for consumption according to the length of the predetermined time;
a user information update unit of associating the game medium for reward with the one user or cancels the association of the game medium for consumption that has been associated with the one user after the predetermined time has elapsed.

[Item 8]

The information processing system according to Item 7,
wherein the advancing management unit is further capable of accepting a second predetermined user's input for shortening or extending the predetermined time until the predetermined time elapses.

[Item 9]

The information processing system according to Item 8,
wherein the information change amount determination unit determines the game medium for reward or the game medium for consumption according to the length of the predetermined time as shortened or extended, when the second predetermined user's input is accepted by the advancing management unit.

[Item 10]

The information processing system according to Items 8 or 9,
wherein the information change amount determination unit determines the game medium for reward according to the length of the predetermined time before shortened or the game medium for consumption according to the length of the predetermined time before extended, when the second predetermined user's input is accepted by the advancing management unit and a predetermined condition associated with the one user is met.

[Item 11]

The information processing system according to any one of Items 7 to 10,

wherein the information change amount determination unit determines the game media for reward or the game media for consumption in such a manner that the longer the predetermined time is, the higher the usefulness of the reward or the greater the consumption amount is.

[Item 12]

The information processing system according to anyone of Items 7 to 11,
wherein the output generating unit further outputs information representing the current elapsed time being clocked by the clocking unit based on a third predetermined user's input until the predetermined time elapses.

[Item 13]

The information processing system according to any one of Ttems 7 to 12,
wherein the information change amount determines unit the game medium for reward or the game medium for consumption according to the current elapsed time being clocked by the clocking unit, and
wherein the output generation unit further outputs information representing the game media for reward or the game media for consumption according to the current elapsed time based on a third predetermined user's input until the predetermined time elapses.

[Item 14]

The information processing system according to Items 1 to 13, further comprising a time setting unit of setting the length of the predetermined time based on the setting input associated with the one user.

[Item 15]

The information processing system according to Items 1 to 14, further comprising
a second game advancing unit of advancing the game part with the first attribute according to a second operation input associated with the one user,
wherein the predetermined start condition includes that a first information indicating that the game part with the first attribute advanced by the second game advancing unit has been cleared is associated with the one user.

[Item 16]

The information processing system according to Item 15,
wherein the predetermined start condition further includes that a second information indicating that a predetermined mission associated with the game part with the first attribute advanced by the second game advancing unit has been cleared is associated with the one user.

[Item 17]

The information processing system according to Items 15 or 16,
wherein the predetermined advancement by the first game advancing unit is realized using a predetermined game medium associated with a predetermined first game parameter value, and
wherein the predetermined start condition further includes a parameter condition to be determined based on the relationship between a value of a predetermined second game parameter associated with the game part with the first attribute and a value of the predetermined first game parameter.

[Item 18]

The information processing system according to any one of Items 15 to 17,
wherein the predetermined start condition further includes that a particular game medium is associated with the one user.

[Item 19]

The information processing system according to any one of Items 1 to 18,
wherein the predetermined advancement by the first game advancing unit includes advancing repeatedly by a predetermined number of the game part with the first attribute associated with the one user.

[Item 20]

The information processing system according to Item 19,
wherein the predetermined number is determined based on the length of the predetermined time and the game medium associated with the one user.

[Item 21]

The information processing system comprising;
a condition determination unit of determining whether or not a predetermined start condition is met; and
a first game advancing unit of automatically realizing advancing repeatedly by a predetermined number of a game part with the first attribute associated with one user when the predetermined start condition is met,
the first game advancing unit comprising:
an information change amount determination unit of determining the game media for reward according to the predetermined number or the game media for consumption according to the predetermined number;
a user information update unit of associating the game medium for reward with the one user and canceling association related to the game medium for consumption having been associated with the one user after advancing repeatedly by the predetermined number of the game part with the first attribute.

[Item 22]

An information processing method performed with a computer, the method comprising:
determining whether or not a predetermined start condition is met;
automatically realizing a predetermined advancement of a game part with a first attribute associated with one user when the predetermined start condition is met;
starting to clock a predetermined time when the predetermined start condition is met;
being capable of outputting a termination result of the predetermined advancement when the predetermined time has elapsed; and
being capable of accepting a first predetermined user's input until the predetermined time elapses.

[Item 23]

A program performed with a computer, the program comprising:
determining whether or not a predetermined start condition is met;
automatically realizing a predetermined advancement of a game part with a first attribute associated with one user when the predetermined start condition is met;
starting to clock a predetermined time when the predetermined start condition is met;
being capable of outputting a termination result of the predetermined advancement when the predetermined time has elapsed; and
being capable of accepting a first predetermined user's input until the predetermined time elapses.

### REFERENCE SIGNS LIST

1 game system;

10 server device;

11 server communication unit;

12 server storage unit;

13 server control unit;

20 terminal device;

21 terminal communication unit;

22 terminal storage unit;

23 display unit;

24 input section;

25 terminal control unit;

30 network;

150 user data storage unit;

153 start condition determination unit;

156 game advancing unit;

210 user data storage unit;

211 user interface generation unit;

212 operational information acquisition unit;

213 start condition determination unit;

214 time setting/management unit;

2141 lap time setting unit (an example of parameter determination unit);

2142 lap time clocking (an example of a count control unit);

215 advancing management unit;

216 first game advancing unit;

2161 information change amount determination unit (an example of a determination unit);

2162 user information update unit;

217 output generation unit;

218 start data generation unit;

219 second game advancing unit;

2191 update processing unit;

2192 determination processing unit;

2193 post-termination processing unit; and

2194 effect production processing unit.

What is claimed is:

1. An information processing system comprising:
processing circuitry configured to:
determine whether a predetermined start condition including consumption of a predetermined game medium is met;
automatically realize a predetermined advancement of a game part with a first attribute associated with one user when it is determined that the predetermined start condition is met;
determine a setting value of a first parameter based on a consumed amount of the predetermined game medium or a consumed type of the predetermined game medium, the first parameter being related to advancement of the game part with the first attribute;
start to count the first parameter to be updated toward the determined setting value of the first parameter, when it is determined that the predetermined start condition is met; and
allow a termination result of the predetermined advancement to be output, when an updated counting value of the first parameter meets a predetermined output condition,
wherein the termination result of the predetermined advancement is determined based on the updated counting value of the first parameter or on the determined setting value of the first parameter.

2. The information processing system according to claim 1,
wherein the first parameter is related to a lapsed time from a starting point regarding the predetermined advancement or to a number of repeating the game part with the first attribute.

3. The information processing system according to claim 2,
wherein the processing circuitry is further configured to increase the setting value of the first parameter as the consumed amount of the predetermined game medium increases.

4. The information processing system according to claim 2,
wherein the setting value of the first parameter is increased in a case where the consumed predetermined game medium is a first type, as compared with a case where the consumed predetermined game medium is a second type.

5. The information processing system according to claim 2,
wherein the processing circuitry is further configured to:
update the counting value of the first parameter so that the counting value of the first parameter increases as the lapsed time from the starting point regarding the predetermined advancement or the number of repeating the game part with the first attribute increases, and
determine, based on a relationship between the updated counting value of the first parameter and the determined setting value of the first parameter, whether the predetermined output condition is met.

6. The information processing system according to claim 2,
wherein the processing circuitry is further configured to associate the termination result with the user such that the user is benefited as the updated counting value of the first parameter increases.

7. The information processing system according to claim 1,
wherein the predetermined output condition is met when a difference between the determined setting value of the first parameter and the updated counting value of the first parameter is equal to or less than a first threshold value.

8. The information processing system according to claim 1,
wherein the processing circuitry is further configured determine the setting value of the first parameter based on a predetermined game condition.

9. The information processing system according to claim 8,
wherein the processing circuitry is further configured to determine the setting value of the first parameter again, when the predetermined game condition is changed along with the predetermined advancement after the predetermined start condition having been met, based on the changed predetermined game condition.

10. The information processing system according to claim 1,
wherein the predetermined advancement is executed in such a manner associated with one or more in-use game media, and
wherein the predetermined start condition is set based on information about the one or more in-use game media.

11. An information processing system comprising;
a processing circuitry configured to:
determine whether a predetermined start condition including consumption of a predetermined game medium is met;
automatically realize a predetermined advancement of a game part with a first attribute, when it is determined that the predetermined start condition is met, the predetermined advancement being advanced using a first player or a first player's character and a second player or a second player's character;
output a termination result of the predetermined advancement; and
determine, based on information about the first player or the first player's character and information about the second player or the second player's character, either information required to realize the predetermined advancement or the termination result.

12. The information processing system according to claim 11,
wherein the information required to realize the predetermined advancement includes the predetermined start condition to start the predetermined advancement, and
wherein the processing circuitry is further configured to determine the predetermined start condition based on the information about the first player or the first player's character and the information about the second player or the second player's character.

13. The information processing system according to claim 11,
wherein the predetermined start condition is met by consuming a predetermined type of game medium or a predetermined number or amount of game medium, and
wherein the processing circuitry is further configured to determine the predetermined start condition based on the information about the first player or the first player's character and the information about the second player or the second player's character.

14. The information processing system according to claim 11,
wherein the information required to realize the predetermined advancement includes information about time or a counting number regarding the predetermined advancement, and
wherein the processing circuitry is further configured to determine, based on the information about the first player or the first player's character and the information about the second player or the second player's character, the time or the counting number regarding the predetermined advancement.

15. The information processing system according to claim 14,
wherein the processing circuitry is further configured to determine, based on the information about the determined time or the determined counting number, a type of event occurring during the predetermined advancement or of privilege obtainable during the predetermined advancement.

16. A non-transitory computer-readable medium having stored a program therein for causing a computer to perform processing of a game, the processing comprising:
determining whether a predetermined start condition including consumption of a predetermined game medium is met;
automatically realizing a predetermined advancement of a game part with a first attribute associated with a user, when it is determined that the predetermined start condition is met;
determining a setting value of a first parameter based on a consumed amount of the predetermined game medium or a consumed type of the predetermined game medium, the first parameter being related to advancement of the game part with the first attribute;
starting to count the first parameter to be updated toward the determined setting value of the first parameter, when it is determined that the predetermined start condition is met; and
allowing a termination result of the predetermined advancement to be output, when an updated counting value of the first parameter meets a predetermined output condition,
wherein the termination result of the predetermined advancement is determined based on the updated counting value of the first parameter or on the determined setting value of the first parameter.

17. A method for processing of a game, comprising:
determining whether a predetermined start condition including consumption of a predetermined game medium is met;
automatically realizing a predetermined advancement of a game part with a first attribute associated with a user, when it is determined that the predetermined start condition is met;
determining a setting value of a first parameter based on a consumed amount of the predetermined game medium or a consumed type of the predetermined game medium, the first parameter being related to advancement of the game part with the first attribute;
starting to count the first parameter to be updated toward the determined setting value of the first parameter, when it is determined that the predetermined start condition is met; and
allowing a termination result of the predetermined advancement to be output, when an updated counting value of the first parameter meets a predetermined output condition,
wherein the termination result of the predetermined advancement is determined based on the updated counting value of the first parameter or on the determined setting value of the first parameter.

18. The information processing system according to claim 2,
wherein the predetermined advancement is executed in such a manner associated with one or more in-use game media, and
wherein the predetermined start condition is set based on information about the one or more in-use game media.

19. The information processing system according to claim 3,
wherein the predetermined advancement is executed in such a manner associated with one or more in-use game media, and
wherein the predetermined start condition is set based on information about the one or more in-use game media.

20. The information processing system according to claim 4,
wherein the predetermined advancement is executed in such a manner associated with one or more in-use game media, and
wherein the predetermined start condition is set based on information about the one or more in-use game media.
